(19) United States
(12) Patent Application Publication
(10) Pub. No.: US 2025/0202854 A1
(43) Pub. Date: Jun. 19, 2025

(54) MESSAGE SYNCHRONIZATION METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Wenjiang SU, Shenzhen (CN); Yingzhong CHEN, Shenzhen (CN); Fen HE, Shenzhen (CN)

(21) Appl. No.: 19/063,486

(22) Filed: Feb. 26, 2025

Related U.S. Application Data
(63) Continuation of application No. PCT/CN2023/131302, filed on Nov. 13, 2023.

(30) Foreign Application Priority Data
Feb. 1, 2023 (CN) 202310130184.2

(51) Int. Cl. H04L 51/21; H04L 67/1095

(52) U.S. Cl. CPC H04L 51/21; H04L 67/1095

(57) ABSTRACT

A message synchronization method includes: displaying a channel conversation page corresponding to a social group channel; the social group channel being a group organization generated by associating M communication groups; M being an integer greater than or equal to 2; displaying, in the channel conversation page in response to a channel message transmission operation triggered in the social group channel, a channel message obtained through the channel message transmission operation; and synchronizing the channel message to the M communication groups.

### CROSS-REFERENCES TO RELATED APPLICATIONS

This application is a continuation of PCT Patent Application No. PCT/CN2023/131302, and filed on Nov. 13, 2023, which claims priority to Chinese Patent Application No. 202310130184.2, filed with the China National Intellectual Property Administration on Feb. 1, 2023 and entitled “MESSAGE SYNCHRONIZATION METHOD AND APPARATUS, DEVICE, AND STORAGE MEDIUM”, both of which are incorporated herein by reference in their entirety.

### FIELD OF THE TECHNOLOGY

The present disclosure relates to the field of Internet and other technologies, and in particular, to a message synchronization method and apparatus, a device, and a storage medium.

### BACKGROUND OF THE DISCLOSURE

With the development of Internet technologies, it is quite common to transmit information through the Internet. For example, conversational communication is performed through an application program. Alternatively, a communication group may be established, and a plurality of group members may be added, to implement a multi-person conversation, thereby bringing great convenience to user communication. However, when a user needs to send the same message to different communication groups, the user needs to switch between conversation pages, and a message sending process is cumbersome, resulting in low message sending efficiency.

### SUMMARY

Embodiments of the present disclosure provide a message synchronization method and apparatus, a device, and a storage medium to simplify a message sending process and improve message sending efficiency.

According to one aspect of the embodiments of the present disclosure, a message synchronization method is provided, including: displaying a channel conversation page corresponding to a social group channel; the social group channel being a group organization generated by associating M communication groups; and M being an integer greater than or equal to 2; obtaining a channel message according to a channel message transmission operation triggered in the social group channel; displaying the channel message in the channel conversation page in response to the channel message transmission operation; and synchronizing the channel message to the M communication groups.

According to one aspect of the embodiments of the present disclosure, a message synchronization method is provided, including: obtaining a group message according to a group message transmission operation triggered in a first communication group; displaying the group message in a group conversation page of the first communication group in response to the group message transmission operation; the first communication group being one of M communication groups corresponding to a social group channel, the social group channel being a group organization generated by associating the M communication groups, and M being an integer greater than or equal to 2; and synchronizing the group message to the social group channel and a remaining communication group of the M communication groups other than the first communication group.

According to one aspect of the embodiments of the present disclosure, a message synchronization method is provided, including: receiving a channel message synchronization request from a channel node corresponding to a social group channel; the channel message synchronization request carrying a channel message; the channel message being transmitted in the social group channel by an object in the social group channel; the social group channel being a group organization generated by associating M communication groups; and M being an integer greater than or equal to 2; and synchronizing the channel message to application nodes corresponding to the M communication groups; the application nodes corresponding to the M communication groups being configured to synchronize the channel message to the M communication groups.

According to one aspect of the embodiments of the present disclosure, a message synchronization method is provided, including: receiving a group message synchronization request from a first application node corresponding to a first communication group; the group message synchronization request carrying a group message transmitted by a target object in the first communication group, the first communication group being one of M communication groups corresponding to a social group channel, the social group channel being a group organization generated after associating the M communication groups, the target object being an object in the first communication group, and M being an integer greater than or equal to 2; and synchronizing the group message to a channel node corresponding to the social group channel and an application node corresponding to a remaining communication group of the M communication groups other than the first communication group; the channel node being configured to synchronize the group message to the social group channel; and the application node corresponding to the remaining communication group being configured to synchronize the group message to the remaining communication group.

According to one aspect of the embodiments of the present disclosure, a message synchronization method is provided, including: receiving a channel message from a terminal corresponding to a target object in a social group channel; the channel message being transmitted by the target object in the social group channel; the social group channel being a group organization generated by associating M communication groups; and M being an integer greater than or equal to 2, and the target object belonging to at least one communication group of the M communication groups; generating a channel message synchronization request; the channel message synchronization request carrying the channel message; and transmitting the channel message synchronization request to a social group node; the social group node being configured to synchronize, according to the channel message synchronization request, the channel message to application nodes corresponding to the M communication groups, and the application nodes corresponding to the M communication groups being configured to synchronize the channel message to terminals corresponding to objects in the M communication groups.

According to one aspect of the embodiments of the present disclosure, a message synchronization method is provided, including: receiving a channel message from a social group node corresponding to a social group channel; the channel message being a message transmitted by a target object in the social group channel, and the social group channel being a group organization generated by associating M communication groups; M being an integer greater than or equal to 2, and the target object belonging to at least one communication group of the M communication groups; and the channel message being transmitted to the social group node by a channel node corresponding to the social group channel; and transmitting the channel message to terminals corresponding to objects in the M communication groups.

According to one aspect of the embodiments of the present disclosure, a message synchronization apparatus is provided, including: a first display module, configured to display a channel conversation page corresponding to a social group channel; the social group channel being a group organization generated by associating M communication groups; and M being an integer greater than or equal to 2; a second display module, configured to display a channel message in the channel conversation page in response to a channel message transmission operation triggered in the social group channel; the channel message being obtained according to the channel message transmission operation; and a synchronization module, configured to synchronize the channel message to the M communication groups.

According to one aspect of the embodiments of the present disclosure, a computer device is provided, including a memory and a processor, the memory stores a computer program, and the computer program is executed by the processor to perform the operations of one or more of the foregoing methods.

According to one aspect of the embodiments of the present disclosure, a non-transitory computer-readable storage medium is provided, having a computer program stored therein, and the computer program is executed by a processor to perform the operations of one or more of the foregoing methods.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel transmits a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

### BRIEF DESCRIPTION OF THE DRAWINGS

FIG. 1 is a schematic diagram of a message synchronization system according to the present disclosure;

FIG. 2 is a schematic structural diagram of a first type of blockchain network for message synchronization according to the present disclosure;

FIG. 3 is a schematic flowchart of a first type of message synchronization method according to the present disclosure;

FIG. 4 is a schematic diagram of an interface of a channel conversation page and a group conversation page according to the present disclosure;

FIG. 5 is a schematic diagram of a scenario of creating a social group channel according to the present disclosure;

FIG. 6 is a schematic diagram of a scenario of creating a social group channel according to the present disclosure;

FIG. 7 is a schematic diagram of a scenario of creating a social group channel according to the present disclosure;

FIG. 8 is a schematic flowchart of a first type of message synchronization method according to the present disclosure;

FIG. 9 is a schematic diagram of an interface of a channel conversation page and a group conversation page according to the present disclosure;

FIG. 10 is a schematic flowchart of a first type of message synchronization method according to the present disclosure;

FIG. 11 is a schematic diagram of a scenario of pushing a channel message to a third-party application program from a main application program according to the present disclosure;

FIG. 12 is a schematic flowchart of a first type of message synchronization method according to the present disclosure;

FIG. 13 is a schematic diagram of a scenario of pushing a channel message to a main application program and another third-party application program from a third-party application program according to the present disclosure;

FIG. 14 is a schematic flowchart of a first type of message synchronization method according to the present disclosure;

FIG. 15 is a schematic diagram of a scenario of requesting a channel aggregated message of a third-party application program in a main application program according to the present disclosure;

FIG. 16 is a schematic flowchart of a first type of message synchronization method according to the present disclosure;

FIG. 17 is a schematic diagram of a scenario of requesting a group aggregated message of a main application program and an application program B in an application program A according to the present disclosure;

FIG. 18 is a schematic structural diagram of a first type of message synchronization apparatus according to an embodiment of the present disclosure;

FIG. 19 is a schematic structural diagram of a second type of message synchronization apparatus according to an embodiment of the present disclosure;

FIG. 20 is a schematic structural diagram of a first type of message synchronization apparatus according to an embodiment of the present disclosure;

FIG. 21 is a schematic structural diagram of a second type of message synchronization apparatus according to an embodiment of the present disclosure;

FIG. 22 is a schematic structural diagram of a first type of message synchronization apparatus according to an embodiment of the present disclosure;

FIG. 23 is a schematic structural diagram of a second type of message synchronization apparatus according to an embodiment of the present disclosure; and

FIG. 24 is a schematic structural diagram of a computer device according to an embodiment of the present disclosure.

### DESCRIPTION OF EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without making creative efforts shall fall within the protection scope of the present disclosure.

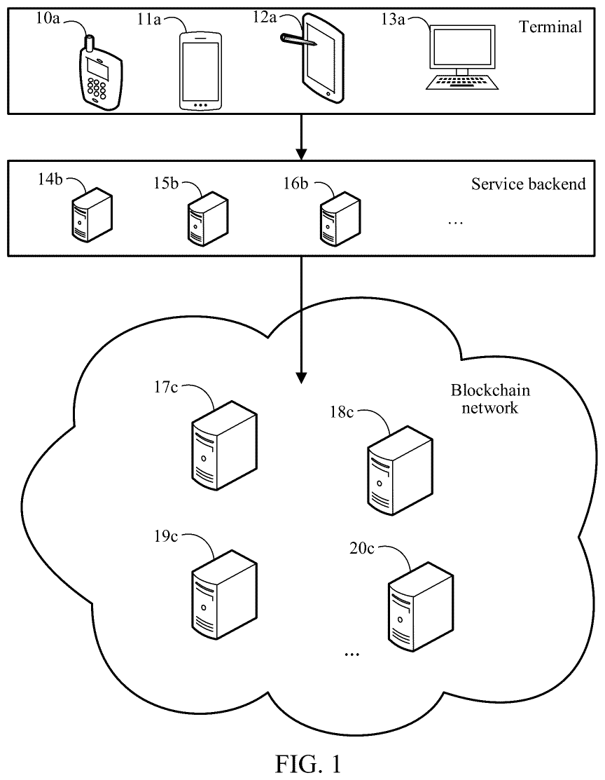

To facilitate clearer understanding of the present disclosure, a message synchronization system for implementing a message synchronization method of the present disclosure is first described. As shown in FIG. 1, the message synchronization system includes a terminal cluster, a first server cluster, and a second server cluster.

The terminal cluster includes a plurality of terminals, for example, a terminal 10a, a terminal 11a, a terminal 12a, and a terminal 13a. Each terminal in the terminal cluster is installed with an application program for communication. For example, the application program includes but is not limited to: a shopping application program, an audio and video application program, an instant messaging application program, a content interaction application program, and the like. A user may create a communication group by using an application program installed in the terminal. One communication group may include a plurality of objects, and a multi-person conversation may be implemented by using the communication group. The application program in the terminal configured to create the communication group may be referred to as a third-party application program. A user may associate communication groups by using an application program installed in a terminal, to obtain a social group channel. The application program in the terminal configured to associate the communication groups to obtain the social group channel may be referred to as a main application program. Generally, the main application program may be an application program whose communication stability is greater than a stability threshold. Stability of the application program may be determined according to at least one of communication efficiency, communication security, a quantity of online people that can be supported, and the like of the application program. In an embodiment, the main application program may be different from a third-party application program. For example, the third-party application program may include an application program 1, an application program 2, and an application program 3, and the main application program may be an application program 4. In another embodiment, the main application program may be one of third-party application programs. For example, the third-party application programs may include an application program 1, an application program 2, and an application program 3, and the main application program may be the application program 3.

The social group channel may be a social group organization created by the user in the main application program, and is configured to provide efficient and diverse services for a communication group of the user. For example, a social relationship chain of the user on a plurality of platforms (application programs) may be conveniently and efficiently operated based on the social group channel. The social group channel may also be referred to as a super social group, and is a large online virtual organization that supports a large quantity of real-time online users (for example, 100,000).

Objects in a social group channel usually have similar features, for example, have the same hobby, have a similar experience, and have the same social relationship (for example, a colleague relationship and a friend relationship). The social group channel may be a group organization generated after associating at least two communication groups. When any object in the social group channel sends a channel message in the social group channel, other objects may view the channel message through the social group channel, and the channel message is synchronized to all the communication groups, which facilitates message intercommunication between different groups (the social group channel and the communication group). Similarly, if any object in the social group channel sends a group message in a communication group to which the object belongs, other objects in the communication group can view the message in the communication group, the group message is also synchronized to the social group channel, and any object in the social group channel can view the group message in the social group channel.

For example, the social group channel is a group organization generated by associating a communication group 1 and a communication group 2. A main application program corresponding to the social group channel may be an application program 1, the communication group 1 belongs to the application program 1, and the communication group 2 belongs to an application program 2. An example of a user 1 is used. It is assumed that the user 1 belongs to at least one of the communication group 1 and the communication group 2. When a terminal 1 (for example, the terminal 10a in FIG. 1) corresponding to the user 1 receives a channel message sent by the user 1 in a social group channel, the terminal 1 may display the channel message in a channel conversation page corresponding to the social group channel, and synchronize the channel message to other objects in the social group channel, and to the communication group 1 and the communication group 2, so that the channel message in the social group channel is synchronized to a plurality of communication groups, and the application program 1 and the application program 2 are interconnected, that is, cross-platform (cross-application program) communication is implemented, thereby improving convenience of communication. For example, the user 1 belongs to the communication group 1. If the terminal 1 receives a group message sent by the user 1 in the communication group 1, the terminal 1 may display the group message in a group conversation page corresponding to the communication group 1, and synchronize the group message to the social group channel and the communication group 2, so that the group message in the communication group 1 is synchronized to a plurality of communication groups (the social group channel and the communication group 2), and the application program 1 and the application program 2 are interconnected, that is, cross-platform (cross-application program) communication is implemented, thereby improving convenience of communication.

The first server cluster includes a plurality of servers, for example, a server 14b, a server 15b, and a server 16b. The servers in the first server cluster are service backends of the application programs in the terminal, and are configured to provide backend services for the application programs in the terminal. The server 14b and the server 15b may be referred to as third-party application program backends corresponding to third-party application programs. For example, the server 14b may be a backend device that provides a service for the application program 1. The server 14b records social information of a registered user in the application program 1. The social information may include a relationship chain and basic information (for example, an account and a nickname). The relationship chain indicates a communication group to which the registered user belongs, friends added by the registered user in the application program 1, and the like. Similarly, the server 15b may be a backend device that provides a service for the application program 2, and the server 15b records social information of a registered user in the application program 2. The server 15b may be a backend device that provides a service for a main application program, and is mainly configured to synchronize, to a communication group, a channel message sent by an object in a social group channel, receive a group message sent by a user in the communication group, and synchronize the group message to a terminal corresponding to an object in the communication group.

As shown in FIG. 1, the second server cluster is a blockchain network including a plurality of servers. For example, the second server cluster includes a server 17c, a server 18c, a server 19c, and a server 20c. The second server cluster is configured to perform message synchronization of a channel message and a group message between a main application program and a third-party application program, and perform relationship chain mapping between the main application program and the third-party application program. The server 17c and the server 18c may be referred to as application nodes of third-party application programs in the blockchain network. For example, the server 17c may be an application node 1 of the application program 1 in the blockchain network, and the server 18c may be an application node 2 of the application program 2 in the blockchain network. The server 19c may be referred to as a channel node of the main application program in the blockchain network, and the server 20c may be referred to as a social group node of the social group channel in the blockchain network. The social group node plays a dominant role and is established depending on consensus (digital member authorization proof) of all members (that is, objects) in the social group channel, manages core information such as a relationship chain and object information of the objects in the social group channel, and is responsible for message aggregation and mapping between a relationship chain of the object in the social group channel in the main application program and a relationship chain of the object in the social group in the third-party application program. The digital member authorization proof herein is used for indicating that an object in the social group channel allows a group message and a channel message sent by the object to be synchronized between the social group channel and the communication group. The digital member authorization proof is generated by synchronizing an authorization message based on a message sent by the object in the communication group when the communication group is added to the social group channel. The digital member authorization proof records an authorization time and a message synchronization range. The message synchronization range includes the social group channel and the communication group of the object in the social group channel. The relationship chain of the object in the social group channel in the main application program indicates a mapping relationship between an object channel identifier of the object in the social group channel and a digital identifier that is of the object in the social group channel and that is in the main application program. The object channel identifier may be a login account, a nickname, or the like of the object in the social group channel in the main application program. The digital identifier is a unique identifier of the object in the social group channel, for example, may be generated based on basic information (for example, identity card numbers) of the object in the social group channel. Alternatively, the digital identifier may be a public key of the object in the social group channel in the blockchain network. Digital identifiers of different objects in the social group channel are different, that is, a digital identifier of any object in the social group channel is unique.

The channel node is responsible for providing a channel message sent in the social group channel by an object in the social group channel and a corresponding channel smart contract of the social group channel, and is responsible for receiving a group message of a third-party application program, and converting a message encapsulation format of the group message of the third-party application program into a channel message encapsulation format corresponding to the main application program, and other message aggregation. The message aggregation herein may include at least one of message format conversion, message sorting (for example, message sorting according to transmission times), and the like. The channel smart contract is configured for performing legality verification on the channel message and the group message, and querying whether a sender of the channel message and the group message has a digital member authorization proof, and the like. The legality verification may refer to verifying whether there is sensitive information in the message (the channel message and the group message), and the like. The channel node synchronizes the message to another node (for example, the social group node) only when the digital member authorization proof of the sender is found and the sent message is legal.

The application node is responsible for providing a group message sent in a communication group by an object in the social group channel and a corresponding group smart contract of the communication group, and is responsible for receiving a channel message from the social group channel and group messages from other communication groups, and performing message encapsulation format conversion on the received message (the channel message and the group messages of the other communication groups), and other message aggregation. The group smart contract is configured for performing legality verification on the received information, querying whether the sender has a digital member authorization proof, and the like. The group smart contract may be the same as or different from the channel smart contract, and the group smart contract and the channel smart contract are contracts on which the nodes in the blockchain network reach consensus.

Information exchange between the social group channel and the communication group is implemented through the blockchain network, which has the following characteristics:
a. A high degree of autonomy of nodes in the blockchain network is implemented. For example, the application node only needs to manage information such as a relationship chain of an object in the social group channel in an application program (that is, a third-party application program) of the application node, and the channel node only needs to manage information such as a relationship chain of an object in the social group channel in the main application program. The relationship chain mapping and the like are collectively implemented by the social group node. The relationship chain mapping includes mapping between a relationship chain that is of an object in the social group channel and that is in a third-party application program and a relationship chain that is of the object in the social group channel and that is in the main application program, and mapping between a relationship chain that is of an object in the social group channel and that is in a third-party application program and a relationship chain that is of the object in the social group channel and that is in another third-party application program.
b. Message intercommunication between different application programs is implemented. A process of performing message intercommunication between different application programs involves interface invocation and data transfer. Interface invocation and message synchronization may be performed in a form of a smart contract (for example, the channel smart contract and the group smart contract). The smart contract is jointly formulated by all members in the blockchain network and is jointly followed. In other words, according to the smart contract, only after all nodes reach consensus, message synchronization can be performed. An execution record (message synchronization, an execution result of the smart contract, and the like) is permanently recorded on the blockchain of the blockchain network, thereby improving data security and being traceable.
c. In the blockchain network, the smart contract and message synchronization in the blockchain network are transparent to participants (for example, a main application program and a third-party application program). Each node can highly autonomously manage data and interests of the node. Formulating the smart contract and electing the social group node also require participation rights and voting rights, and have a capability against system risks to some extent.
d. The social group node implements unified management of the application programs. For example, the social group node implements mapping of relationship chains that are of objects in the social group channel and that are in different application programs, and aggregates messages of different application programs. The social group node may be elected by nodes in the blockchain network, or the social group node may be configured by an agency corresponding to the main application program.

The blockchain network formed by the application node, the channel node, and the social group node may be a consortium blockchain network or a public blockchain network. The public blockchain network is a consensus blockchain network in which anyone can read and send transaction data and can obtain valid confirmation. The blockchain network is completely decentralized, on-chain data is publicly transparent and unchangeable, and any person can read and write data through transactions. In other words, the public blockchain network may serve for message interaction between the main application program and the third-party application program, and may further be used for providing other services (for example, recording invoices and declaring taxes). The consortium blockchain network refers to a blockchain network in which several organizations or agencies (for example, an agency corresponding to a third-party application program and an agency corresponding to a main application program) jointly participate in the management. Each organization or agency manages one or more nodes and jointly records transaction data. Only an organization or an agency in the consortium can perform data reading/writing or transaction sending on a blockchain in the consortium blockchain network. In other words, the consortium blockchain network serves only for message interaction between the main application program and the third-party application program, and is not configured to provide other services, and may also be referred to as a private blockchain network.

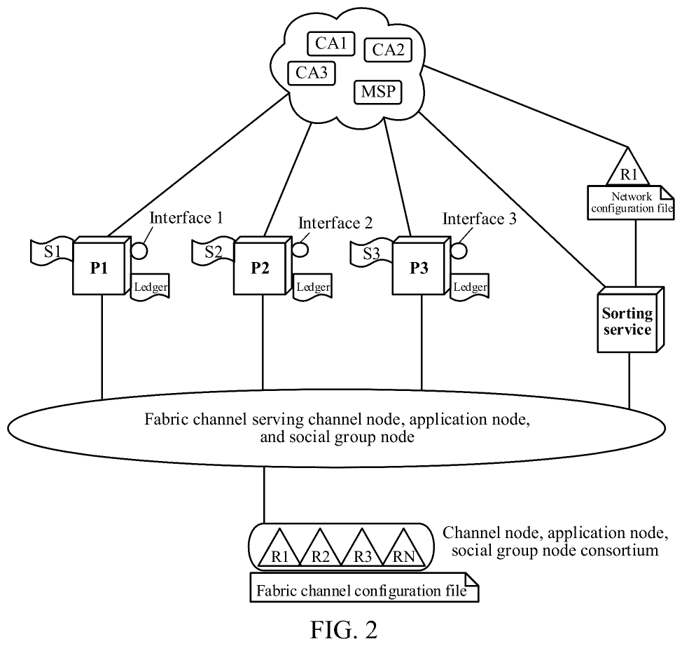

As shown in FIG. 2, for example, the blockchain network formed by the application node, the channel node, and the social group node is a consortium blockchain network. As shown in FIG. 2, P1, P2, and P3 are all nodes in the consortium blockchain network, and application programs corresponding to the nodes may be referred to as members of the consortium blockchain network. For example, P1 may be the channel node, P2 is the application node, and P3 is the social group node. That is, a main application program corresponding to the social group channel and a third-party application program corresponding to the application node are both members of the consortium blockchain network. The nodes are connected through interfaces. For example, P1 and P2 are connected through an interface 1 of P1 and an interface 2 of P2, P2 and P3 are connected through the interface 2 of P2 and an interface 3 of P3, and P1 and P3 are connected through the interface 1 of P1 and the interface 3 of P3. Each node may include a smart contract corresponding to the node. For example, P1 includes a smart contract S1. The smart contract S1 may be the foregoing channel smart contract. P2 includes a smart contract S2. The smart contract S2 may be the foregoing group smart contract. P3 includes a smart contract S3. The smart contract S3 indicates how the social group node synchronizes messages, maps relationship chains, and the like. Each node in FIG. 2 has the same ledger, and the ledger may be configured to record a channel message in the social group channel sent by an object in the social group channel, a group message in a communication group sent by the object in the social group channel, member information of the object in the social group channel, and the like.

The consortium blockchain network may further include an identity verification node cluster. The identity verification node cluster includes nodes corresponding to a plurality of certificate authorities (CA1, CA2, and CA3) and a member service providing node (MSP). The certificate authority (CA) is an agency that issues digital certificates. The certificate authority is an authority responsible for issuing and managing digital certificates (for example, the foregoing digital member authorization proof), serves as a trusted third party, and assumes the responsibility of verifying legality of public keys in a public key system. The member service providing node (MSP) is a component that provides an abstract member operation framework. The member service providing node abstracts all cryptographic mechanisms and protocols related to certificate issuance and verification and user authentication. In other words, there are a plurality of participants (a plurality of nodes) in a running consortium blockchain network. The MSP serves to manage the participants, and may verify permissions of the nodes and maintain relationships between the participants.

The consortium blockchain network may further include a sorting service node. The sorting service node is configured to sort messages (the channel message and the group message) according to transmission times of the messages.

An agency (or an organization) to which the social group channel belongs creates an initial network configuration file of the consortium blockchain network. The initial network configuration file is used for configuring nodes in the consortium blockchain network, and the like. The initial network configuration file defines a consortium formed by the channel node, the application node, and the social group node, and creates a consortium channel (that is, a fabric channel) for the consortium blockchain network. The consortium channel is used for message synchronization between the social group node, the application node, and the channel node. The consortium channel is managed through a channel configuration file. The channel configuration file is jointly managed by all channel members (that is, a network manager R1 of the main application program, a network manager R2 of the third-party application program, and a network manager R3 of the social group channel), and each member has equal rights.

The consortium blockchain network allows addition of a new node. For example, when a user 1 newly adds a communication group 2 to a social group channel, a terminal corresponding to the user 1 sends an addition authorization request to a terminal of an object in the communication group 2. If an authorization permission message (that is, the foregoing message synchronization authorization message) of the object in the communication group 2 is received, the terminal corresponding to the user 1 generates a group addition request for addition to the social group channel, and sends the group addition request to a service backend of an application program 2 to which the communication group 2 belongs. The service backend of the application program 2 sends the group addition request and the authorization permission message to any node in the consortium blockchain network. If the application program 2 belongs to a member in the consortium blockchain network, that is, the consortium blockchain network includes the application node 2 corresponding to the application program 2, a node corresponding to a certificate authority in the consortium blockchain network may generate a digital member authorization proof of the object in the communication group 2 according to the authorization permission message. The digital member authorization proof indicates that the object in the communication group 2 agrees to be added to the social group channel, and agrees to synchronize, between the social group channel and the communication group, the message sent by the object. Specifically, one object corresponds to one digital member proof, and only an object in the communication group 2 that sends an authorization permission message has the digital member authorization proof. Then, the digital member authorization proof is stored in a blockchain (that is, a ledger) in the consortium blockchain network, and each node in the consortium blockchain network can view the newly generated digital member authorization proof from its own ledger.

Further, if the application program 2 is not a member of the consortium blockchain network, that is, the consortium blockchain network does not include the application node corresponding to the application program 2, each node in the consortium blockchain network may verify, according to a permission mechanism in the consortium blockchain network, whether the application program 2 meets a condition for being added to the consortium blockchain network, to obtain a verification result. For example, the permission mechanism may refer to verifying whether a security level of the application program 2 is greater than a security level threshold. In this case, the security level of the application program 2 is greater than the security level threshold, and it is determined that the application program 2 meets the condition for being added to the consortium blockchain network. If the security level of the application program 2 is less than the security level threshold, it is determined that the application program 2 does not meet the condition for being added to the consortium blockchain network. If the verification result indicates that the application program 2 does not meet the condition for being added to the consortium blockchain network, any node (for example, a social group node or a channel node) in the consortium blockchain network may send an addition failure message to the service backend corresponding to the application program 2, and the service backend sends the addition failure message to the terminal corresponding to the user 1. If the verification result indicates that the application program 2 meets the condition for being added to the consortium blockchain network, the node corresponding to the certificate authority in the consortium blockchain network may generate the digital member authorization proof of the object in the communication group 2 according to the authorization permission message, and store the digital member authorization proof in the blockchain (that is, the ledger) in the consortium blockchain network. In this case, an agency to which the social group channel belongs or an agency to which the communication application program 2 belongs adds a candidate application node to the consortium blockchain network. The channel node may configure the candidate application node according to the initial network configuration file, and synchronize a ledger to the candidate application node, to obtain the application node 2 corresponding to the application program 2, that is, the application node 2 is successfully added to the blockchain network.

After the digital member authorization proof of the object in the communication group 2 is generated, the channel node may add, to the social group channel, the object (that is, the authorized object) in the communication group 2 that sends the authorization permission message, the service backend corresponding to the social group channel may return a relationship chain that is of the authorized object in the communication group 2 and that is in the social group channel to the social group node, and the service backend corresponding to the application program 2 returns a relationship chain that is of the authorized object in the communication group 2 and that is in the communication group to the social group node. The social group node adds the relationship chain that is of the authorized object in the communication group 2 and that is in the communication group and the relationship chain that is of the authorized object in the communication group 2 and that is in the social group channel to a relationship chain list. The relationship chain list herein is a list configured for recording relationship chains that are of the objects in the social group channel and that are in various application programs.

The server can be an independent one physical server, or a server cluster composed of at least two physical servers or a distributed system, or can be a cloud server that provides basic cloud computing services such as cloud services, cloud databases, cloud computing, cloud functions, cloud storage, and network services, cloud communications, middleware services, domain name services, security services, content delivery networks (CDN), big data, and artificial intelligence platforms. The terminal can specifically be an in-vehicle terminal, a smartphone, a tablet computer, a laptop computer, a desktop computer, a smart speaker, a screen speaker, a smart watch, and the like, but is not limited to these. Each terminal and each server can be directly or indirectly connected through wired or wireless communication, and numbers of terminals and servers can be one or at least two, which is not limited in the present disclosure.

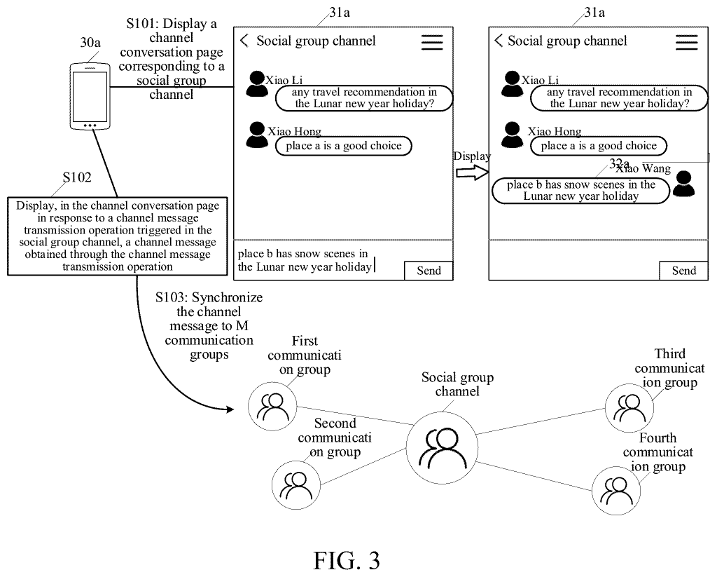

Further, FIG. 3 is a schematic flowchart of a type of message synchronization method according to an embodiment of the present disclosure. As shown in FIG. 3, the method may be performed by any terminal in FIG. 1. A terminal configured to perform the method may be a target terminal, and the target terminal may be a terminal corresponding to any object in a social group channel. The method may include the following operations:

S101: Display a channel conversation page corresponding to a social group channel. The social group channel is a group organization generated by associating M communication groups. M is an integer greater than or equal to 2.

In the present disclosure, the M communication groups may belong to the same application program or may belong to K application programs, where K is a positive integer greater than 1 and less than or equal to M. The K application programs may be maintained by K different companies or software developers, such as Weibo, Rednote, Tiktok, etc. That is, at least two communication groups of the M communication groups belong to different application programs. The M communication groups have an association relationship, and the association relationship between the communication groups has the following meaning: a. Any one of the M communication groups has the same object as that of at least one of the M communication groups. For example, the M communication groups include a communication group 1, a communication group 2, and a communication group 3. Both the communication group 1 and the communication group 2 have a user 1 and a user 2, and both the communication group 2 and the communication group 3 have the user 1 and a user 3. b. After the M communication groups are associated to obtain the social group channel, message synchronization can be performed between the M communication groups, and the M communication groups can be interconnected to each other. In particular, after the M communication groups are associated to obtain the social group channel, objects in the M communication groups remain unchanged. However, any communication group can synchronize to (that is, receive) a group message sent in any communication group by an object in the social group channel, and synchronize to a channel message sent in the social group channel by any object in the social group channel. In other words, after the M communication groups are associated to obtain the social group channel, the M communication groups are also equivalent to a super social group, but there is no need to make any changes to application programs corresponding to the M communication groups, thereby improving convenience of message synchronization.

The social group channel may be equivalent to a super social group. The social group channel includes a channel type, a channel account, an object, and the like. The channel type may be a topic of the social group channel (that is, a name of the social group channel), and indicates at least one of a relationship between objects in the social group channel, content interacted by the objects, and a function of the social group channel. For example, the topic of the social group channel is xx product communication, and indicates that the objects in the social group channel are objects interested in the xx product, and content interacted by the objects is related to the xx product. The objects in the social group channel all belong to the M communication groups. The social group channel may include all the objects in the M communication groups. The objects in the M communication groups all have object channel identifiers in the social group channel. If the objects in the M communication groups are registered objects in the application program corresponding to the social group channel, the object channel identifiers may be nicknames, accounts, or the like of the objects in the M communication groups in the main application program corresponding to the social group channel. If the objects in the M communication groups are not registered objects in the application program corresponding to the social group channel, the object channel identifiers may be nicknames, accounts, or the like of the objects in the M communication groups in an application program to which a corresponding communication group belongs. If an object belongs to a plurality of communication groups, an object channel identifier of the object is a nickname or an account generated by the main application program for the object (registration does not need to be performed). Alternatively, the object channel identifier of the object is a nickname or an account used when the object synchronizes a message to the social group channel for the first time. For example, the social group channel includes a communication group 1 and a communication group 2, the user 1 belongs to the communication group 1 and the communication group 2, and after the communication group 1 and the communication group 2 are added to the social group channel, the user 1 sends a group message in the communication group 1 for the first time. In this case, the object channel identifier of the user 1 in the social group channel is a nickname or an account of the user 1 in the communication group 1. Alternatively, the object channel identifier is an account or a nickname of an object in an application program to which an earliest communication group belongs, and the earliest communication group is a communication group that is earliest added to the social group channel among communication groups including the object. For example, the social group channel includes a communication group 1 and a communication group 2, the user 1 belongs to the communication group 1 and the communication group 2, and the communication group 1 is added to the social group channel earlier than the communication group 2, that is, the earliest communication group is the communication group 1. In this case, an object channel identifier of the user 1 in the social group channel is a nickname or an account of the user 1 in the communication group 1.

Specifically, the object in the social group channel has an object group identifier in all the M communication groups. The object group identifier indicates an object in the social group channel that sends a message. The object group identifier of the object in the social group channel in the communication group to which the object belongs is a nickname or an account of the corresponding object. The object group identifier of the object in the social group channel in the communication group to which the object does not belong may be a channel identifier of the corresponding object. For example, the social group channel includes a communication group 1, a communication group 2, and a communication group 3. The user 1 belongs to the communication group 1 and the communication group 2. An object group identifier of the user 1 in the communication group 1 is an account or a nickname of the user 1 in the communication group 1. An object group identifier of the user 1 in the communication group 2 is an account or a nickname of the user 1 in the communication group 2. An object group identifier of the user 1 in the communication group 3 may be an object channel identifier of the user 1 in the social group channel or may be randomly generated. The social group channel may be created by an object in the social group channel. After the social group channel is created, any object in the social group channel may add, to the social group channel, a communication social group created by the object in an application program. That is, the M communication groups corresponding to the social group channel may be added by one object in the social group channel, or may be added by a plurality of objects in the social group channel, and one communication group is added by one object in the social group channel. In particular, after the social group channel is created, if an object in the social group channel is a registered user in the main application program, the social group channel is also displayed in an address book corresponding to the main application program. In the subsequent description, each object in the social group channel is a registered user in the main application program.

The objects in the social group channel change with a change of the objects in the communication group. For example, if an object is added to the communication group associated with the social group channel, the added object is also added to the social group channel. Similarly, when an object is removed from the communication group associated with the social group channel, the removed object is also removed from the social group channel. When the communication group associated with the social group channel is disbanded (that is, all objects in the communication group are removed), all the objects in the disbanded communication group are also removed from the social group channel.

When a communication group is added to the social group channel, the communication group is also equivalent to a super social group. A quantity of members in the communication group does not change. However, the communication group can receive a message sent by any object in the social group channel. In other words, the communication group can receive a channel message sent in the social group channel by any object in the social group channel, and a group message sent in the M communication groups by any object in the social group channel. In short, messages that can be received by the social group channel are the same as those received by the M communication groups.

When a communication group is associated with (that is, added to) a social group channel, a service backend corresponding to the communication group may add an association identifier to the communication group. The association identifier is used for indicating that the communication group is associated with the social group channel, that is, the association identifier is used for indicating that the communication group is changed to a super social group. A terminal corresponding to the object in the communication group may display the association identifier in the group conversation page of the communication group, to prompt a user that a sent message is to be synchronized between the social group channel and the communication group associated with the social group channel. The association identifier may be at least one of a symbol, a text, or a graphic.

S102: Display, in the channel conversation page in response to a channel message transmission operation triggered in the social group channel, a channel message obtained through the channel message transmission operation.

In operations S101 and S102, when any object in the social group channel sends a message to the social group channel, the sent message may be referred to as a channel message, and the channel message may be a session message, a group announcement, a file, a group activity, or the like. Correspondingly, a target terminal may display a channel conversation page corresponding to the social group channel, and in response to a channel message transmission operation triggered in the social group channel, display, in the channel conversation page corresponding to the social group channel, the channel message obtained through the channel message transmission operation, to synchronize the channel message to objects in different communication groups through the same social group channel. The channel message may be inputted by an object in the social group channel in the social group conversation page, or the channel message may be forwarded from another page, or the channel message may be obtained locally from a terminal of the object in the social group channel.

For example, as shown in FIG. 3, the social group channel is obtained by associating a first communication group, a second communication group, a third communication group, and a fourth communication group. Xiao Wang is used as an example. Xiao Wang belongs to the first communication group and the second communication group of the M communication groups, the first communication group further includes Xiao Hong and Xiao Li, and the second communication group further includes Xiao Li. Certainly, the first communication group and the second communication group further include other objects, which are not described one by one herein. A terminal 30a corresponding to Xiao Wang may display a channel conversation page 31a of a social group channel. History messages are displayed in the channel conversation page 31a. The history messages include a first history message sent by Xiao Li (that is, any travel recommendation in the Lunar new year holiday) and a second history message sent by Xiao Hong (that is, place a is a good choice). The first history message may be sent by Xiao Li in the second communication group, the first communication group, or the social group channel, and the second history message may be sent by Xiao Hong in the first communication group or the social group channel. After Xiao Wang inputs a channel message in the channel conversation page 31a, the terminal 30a obtains, in response to the channel message transmission operation performed on the social group channel, a channel message 32a (that is, place b has snow scenes in the Lunar new year holiday) inputted by Xiao Wang in the channel conversation page 31a, and displays the channel message 32a in the channel conversation page 31a. Further, the terminal 30a may synchronize the channel message 32a to a terminal corresponding to an object in the social group channel other than Xiao Wang, and synchronize the channel message 32a to the first communication group, the second communication group, the third communication group, and the fourth communication group.

For example, the channel message transmission operation is initiated by a target object, and operation S102 may include: in response to the channel message transmission operation performed by a target object in the social group channel on the social group channel, displaying, by a target terminal in a channel conversation page corresponding to the target object, a channel message obtained through the channel message transmission operation; and synchronizing the channel message to a first remaining object in the social group channel other than the target object, that is, sending the channel message to a service backend corresponding to the social group channel, so that the service backend sends the channel message to a terminal corresponding to the first remaining object in the social group channel. The channel message is displayed in the channel conversation page corresponding to the first remaining object. In other words, all objects in the social group channel can view the channel message through the social group channel, thereby improving message sending efficiency.

Operation S102 may include: displaying, by a target terminal in the channel conversation page in response to the channel message transmission operation triggered in the social group channel, a channel aggregated message including the channel message. The channel aggregated message is obtained by aggregating the channel message and a to-be-displayed channel message that is to be displayed in the social group channel, and the to-be-displayed channel message is a group message transmitted in the M communication groups by an object in the social group channel. In other words, the social group channel not only displays the channel message transmitted in the social group channel by the object in the social group channel, but also displays the group message transmitted in the M communication groups by the object in the social group channel, thereby implementing the interconnection between the social group channel and the communication groups and improving the message synchronization efficiency.

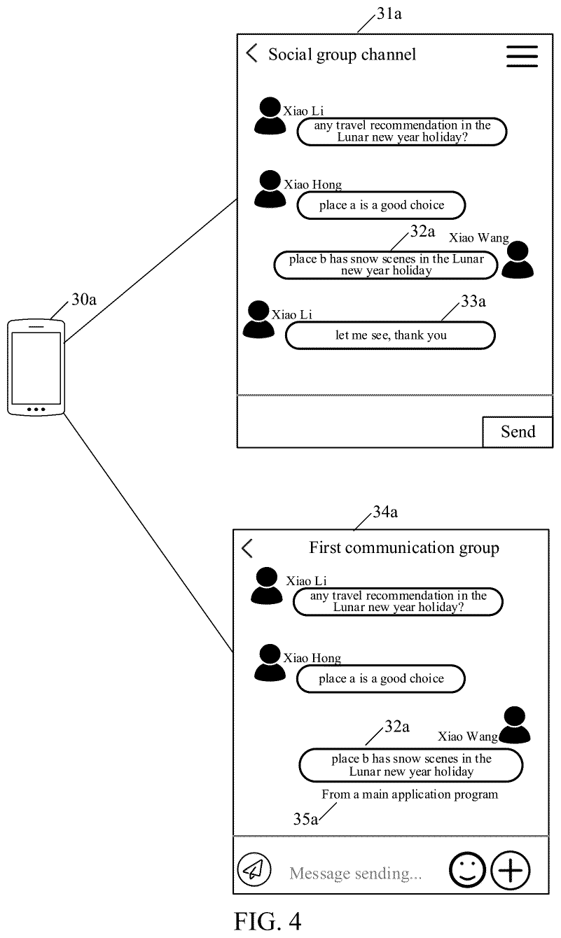

For example, referring to FIG. 3 and FIG. 4, the first communication group in FIG. 3 belongs to the first application program. The terminal 30a may display a channel aggregated message in the channel conversation page 31a. The channel aggregated message includes the channel message 32a and a to-be-displayed channel message 33a (that is, let me see, thank you). The to-be-displayed channel message is sent by Xiao Li in the first communication group in the first application program. A transmission time of the channel message 32a is earlier than a transmission time of the to-be-displayed channel message 33a.

The aggregating the channel message and the to-be-displayed channel message that is to be displayed in the social group channel includes: converting a message encapsulation format of the to-be-displayed channel message into a message encapsulation format corresponding to the social group channel, and sorting the channel message and the to-be-displayed channel message whose format is converted, for example, sorting, according to transmission times, the channel message and the to-be-displayed channel message whose format is converted. The channel aggregated message may be returned by a service backend of a main application program corresponding to the social group channel. The service backend may periodically (for example, every 10 s or when there is a viewing requirement) obtain the to-be-displayed channel message from application nodes corresponding to other application programs, and aggregate the channel message and the to-be-displayed channel message. In this way, frequent message return to the terminal can be avoided, and message transmission overheads can be reduced. S103: Synchronize the channel message to the M communication groups.

In the present disclosure, the target terminal may synchronize the channel message to the terminal corresponding to the object in the M communication groups, that is, the object in the communication group may view the channel message through the communication group. When the M communication groups all belong to the K application programs, that is, when the M communication groups belong to a plurality of different application programs, the plurality of application programs are interconnected by using the social group channel, to implement message synchronization of the plurality of application programs by using the same social group channel, thereby avoiding overheads caused by switching between the plurality of application programs to synchronize a plurality of messages. When the M communication groups all belong to one application program, that is, when the M communication groups belong to the same application program, the plurality of application programs are interconnected by using the social group channel, to implement message synchronization of the plurality of communication groups by using the same social group channel, thereby avoiding overheads caused by switching between conversation pages of the plurality of communication groups to synchronize a plurality of messages.

Further, the target terminal may display the channel message and source information of the channel message in a group conversation page of a first communication group in response to a message viewing operation performed on the first communication group. The source information of the channel message indicates that the channel message comes from the social group channel. For example, the source information of the channel message may include a program identifier of a main application program corresponding to the social group channel, and the program identifier may be at least one of a text, a graphic, or a symbol. In other words, when the to-be-displayed message in the first communication group does not come from an application program corresponding to the first communication group (that is, the to-be-displayed message is not sent in the first communication group), for example, the to-be-displayed message includes at least one of a channel message sent in the social group channel by an object in the social group channel and a group message sent in a remaining communication group, the source information of the to-be-displayed message may be displayed in the first communication group. The remaining communication group may be a communication group of the M communication groups other than the first communication group.

For example, referring to FIG. 3 and FIG. 4, the first history message is sent by Xiao Li in the first communication group and the second history message is sent by Xiao Hong in the first communication group in FIG. 3. An application program to which the first communication group belongs is a first application program, an application program to which the second communication group belongs is a second application program, the social group channel belongs to a main application program, and the main application program is different from the first application program and the second application program. The terminal 30a corresponding to Xiao Wang may display the channel message 32a and source information 35a (that is, from the main application program) of the channel message 32a in a group conversation page 34a of the first communication group in response to a message viewing operation performed on the first communication group. The source message 35a is used for prompting that the channel message 32a comes from the main application program corresponding to the social group channel, that is, the channel message 32a is sent in the social group channel. Because the source information of the first history message and the second history message is not displayed in the group conversation page 34a of the first communication group in FIG. 4, it indicates that the first history message and the second history message both come from the first application program, that is, the first history message is sent by Xiao Li in the first communication group, and the second history message is sent by Xiao Hong in the first communication group. The displaying the channel message in a group conversation page of a first communication group corresponding to the target object includes: displaying, by the target terminal, a group aggregated message including the channel message in the group conversation page of the first communication group; where the group aggregated message is obtained by aggregating the channel message and a to-be-displayed group message that is to be displayed in the first communication group, and the to-be-displayed group message is a group message transmitted in the M communication groups by an object in the social group channel. The group aggregated message may be returned by a service backend corresponding to the first application program corresponding to the first communication group. The service backend may periodically (for example, every 10 s or when there is a viewing requirement) obtain the to-be-displayed group message from application nodes corresponding to the M communication groups, and aggregate the channel message and the to-be-displayed group message. In this way, frequent message return to the target terminal can be avoided, and message transmission overheads can be reduced.

Any object in the social group channel may add the communication group associated with the target object to the social group channel. For example, the target object adds the communication group associated with the target object to the social group channel. The target terminal may display a candidate application list in response to a group addition request of the target object for the social group channel. The candidate application list includes at least one candidate application program, and the candidate application program may be an application program including the communication group associated with the target object. In response to a selection operation performed on a second application program in the candidate application list, a communication group associated with the target object in the second application program is displayed. The communication group associated with the target object in the second application program may include a communication group created by the target object in the second application program and a communication group that is created by a non-target object in the second application program and that includes the target object. Further, the target terminal may add an object in the second communication group to the social group channel in response to a selection operation performed on the second communication group associated with the target object in the second application program. In this way, communication groups in the plurality of application programs can be uniformly managed through the social group channel, and message sending efficiency can be improved.

The adding an object in the second communication group to the social group channel in response to a selection operation performed on a second communication group associated with the target object in the second application program includes: generating, by the target terminal, an addition authorization request in response to the selection operation on the second communication group associated with the target object in the second application program, and transmitting the addition authorization request to the object in the second communication group. The addition authorization request is configured for adding an object in the second communication group to the social group channel. The addition authorization request includes authorization prompt information, the authorization prompt information is displayed in the group conversation page of the second communication group, the authorization prompt information includes channel description information of the social group channel and message synchronization prompt information, and the message synchronization prompt information is configured for prompting that after the object in the second communication group is added to the social group channel, a group message and a channel message transmitted by the object in the second communication group are allowed to be synchronized in the social group channel and the communication group in the social group channel. The channel description information includes one or more of information about a creator in the social group channel, a current quantity of communication groups in the social group channel, a channel type, a channel function, and the like. If an authorization permission message that is transmitted by an object in the second communication group and that relates to the authorization request is received, the object in the second communication group that sends the authorization permission message is added to the social group channel. The authorization permission message is used for indicating that the object in the second communication group allows to be added to the social group channel, and allows message synchronization between the social group channel and the communication group.

Specifically, for continuity and readability of messages in the second communication group and the social group channel, the target terminal may add all the objects in the second communication group to the social group channel when receiving authorization permission messages of all the objects in the second communication group. For example, a user A in the second communication group sends an authorization permission message, and a user B in the second communication group does not send an authorization permission message. If only the user A is added to the social group channel and the user B is not added to the social group channel, the user B cannot synchronize, to the social group channel, a message sent by the user B in the second communication group, and a group message sent by the user A in the second communication group can be synchronized to the social group channel. In this case, if the user B sends a group message 2 in the second communication group, for example, “where is there a concert recently?”, and the user A sends a group message 1 in the second communication group, for example, xx stadium, the group message 2 is not synchronized to the social group channel, and the group message 1 is synchronized to the social group channel. As a result, message context in the social group channel is not continuous and readability is reduced.

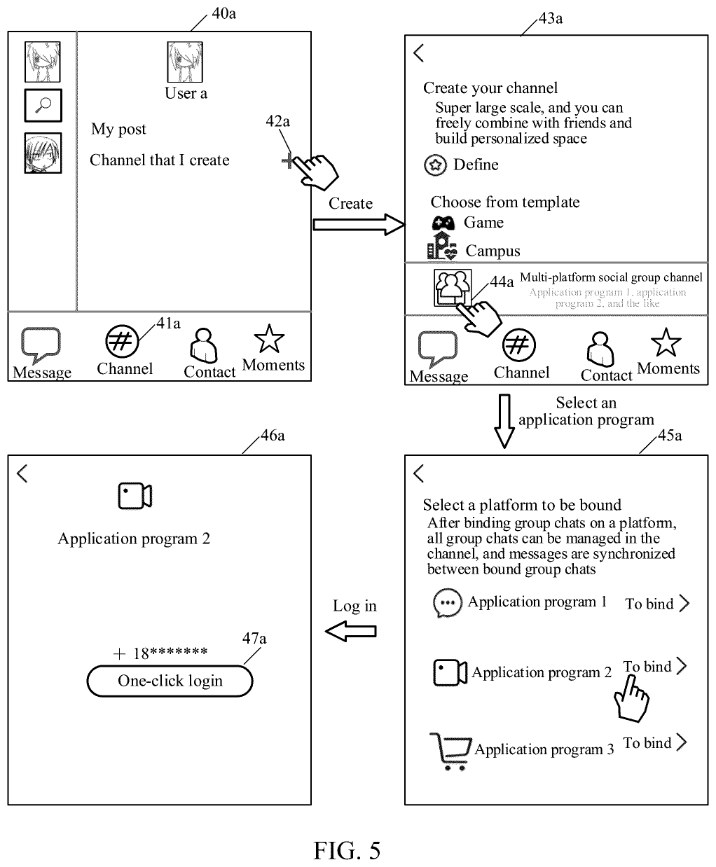

Communication groups in the plurality of different application programs are associated to obtain the social group channel, so that members in different application programs are connected through the unified social group channel, that is, members distributed in different application programs are aggregated into one social group channel, thereby improving user communication experience and expanding impact of operating activities. Members (for example, an administrator) in the social group channel are incentivized to plan higher-cost and more refined activities, and other members in the social group channel have wider choices and obtain a better experience, providing richer and more flexible operating capabilities to the cross-platform social group. Based on the social group feature of aggregation provided by the social group channel, a manager of the social group channel may set communication permissions (for example, a permission to send information and a permission to receive information) of members in the social group channel. For example, as shown in FIG. 5, a user a creates a social group channel (that is, adds a communication group to the social group channel). A terminal a corresponding to the user a may display a channel viewing option 41a in a main application program corresponding to the social group channel. The channel viewing option 41a may be presented in at least one form of graphic, text, symbol, key, or the like. In FIG. 5, the channel viewing option 41a is presented in a form of text (that is, a channel). The terminal a may display the channel creation page 40a on the main application program in response to a trigger operation 1 performed on the channel viewing option 41a. The channel creation page 40a includes a channel creation option 42a. The channel creation option 42a may be presented in at least one form of graphic, text, symbol, key, or the like. In FIG. 5, the channel creation option 42a is presented by adding a corresponding symbol. The terminal a may display a channel creation subpage 43a in response to a trigger operation 2 performed on the channel creation option 42a, and create a social group channel of the user a, that is, allocate an account to the social group channel of the user. The channel creation subpage 43a includes a social group creation option 44a. The social group creation option 44a is configured for associating communication groups in a plurality of application programs to obtain the social group channel. The terminal a may display an application program presentation page 45a in response to a trigger operation 3 performed on the social group creation option 44a. The application program page 45a includes a candidate application list. The candidate application list includes a plurality of candidate application programs associated with the user a. The candidate application program may be an application program in which the user a has a communication group. The candidate application list includes an application program 1, an application program 2, and an application program 3. The terminal a displays a login page 46a of the application program 2 in response to a selection operation performed on any candidate application program (for example, the application program 2 in FIG. 5) in the candidate application list. The login page 46a is used by the user a to enter account information (for example, an account and a password) to log in to the application program 2.

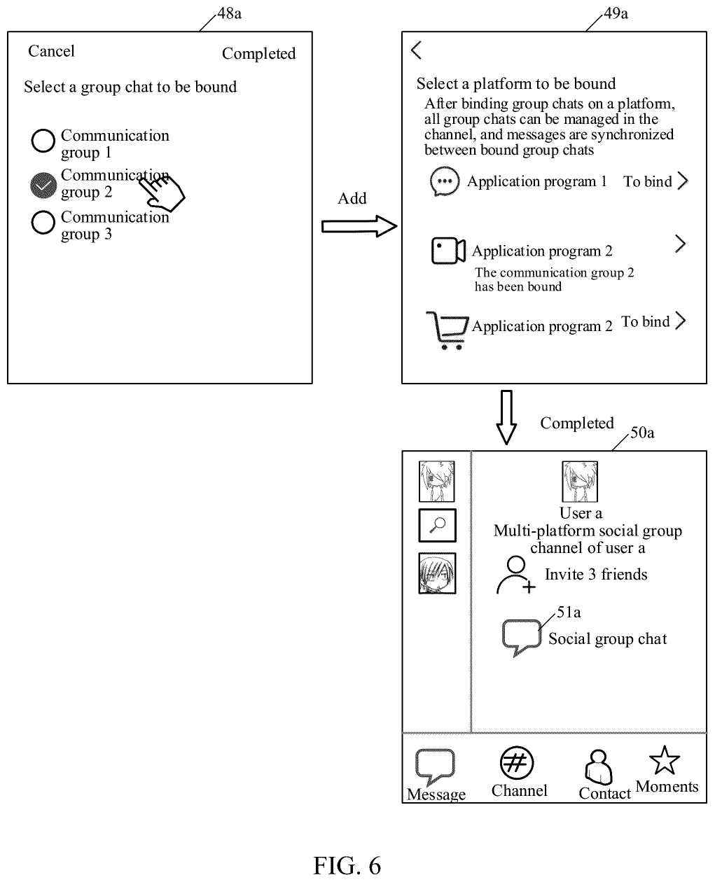

Further, the terminal a may obtain, from the login page 46a, account information entered by the user a, and display a group display page 48a in response to a trigger operation 4 performed on a login option 47a of the login page 46a. A communication group list is displayed in the group display page 48a, and the communication group list includes a communication group associated with the user a in the application program 2. As shown in FIG. 6, communication groups associated with the user a in the application program 2 include a communication group 1, a communication group 2, and a communication group 3. In response to a selection operation performed by the user a on one or more communication groups in the communication group list, the terminal a may display a selection result page 49a. The selection result page 49a is configured to display the communication group selected by the user a. As shown in FIG. 6, the selection result page 49a indicates that the user a selects the communication group 2. That is, in this case, there is already an association relationship (that is, a binding relationship) between the communication group 2 and the social group channel (an account of the social group channel of the user a) created by the user a. The terminal a may display a social group channel 51a in a social group detail page 50a. The social group detail page 50a is configured to display the social group channel created by the user a, including the social group channel of the user a and the like. In this case, members in the communication group 2 have not been added to the social group channel 51a, that is, the members in the communication group 2 are added to the social group channel 51a only when an authorization permission message is received.

In response to the trigger operation 3 performed on the social group creation option 44a, the terminal a may obtain user information (for example, phone numbers) entered by the user in the channel creation subpage, and display, in the channel creation subpage based on the user information of the user, communication groups associated with the user in a plurality of application programs. The communication groups are available for the user to select. In this way, there is no need to switch between the plurality of application programs, thereby improving convenience of adding a communication group in the social group channel.

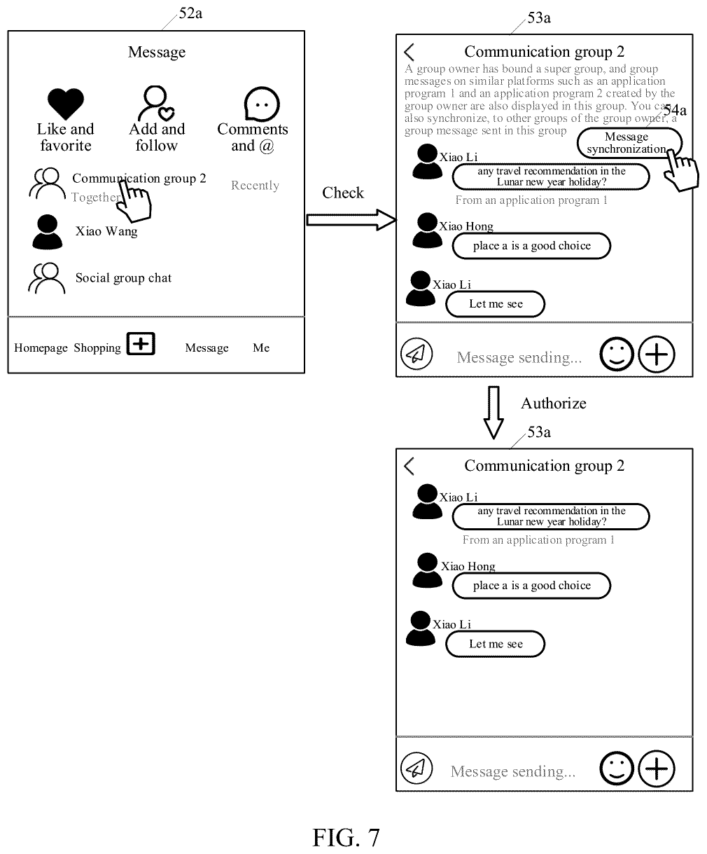

Further, as shown in FIG. 6, the terminal a may send an addition authorization request to a terminal corresponding to an object in the communication group 2. The addition authorization request includes authorization prompt information. After receiving the addition authorization request, the terminal corresponding to the object in the communication group 2 may display, in the group conversation page corresponding to the communication group 2, the authorization prompt information carried in the addition authorization request. As shown in FIG. 7, for example, the communication group 2 includes a user b. A terminal b corresponding to the user b may display a message viewing page 52a in an application program to which the communication group 2 belongs, and the message viewing page 52a displays a to-be-viewed message. Assuming that there is a to-be-viewed message in the communication group 2, the terminal b displays the to-be-viewed message, authorization prompt information, and a confirmation option 54a in a conversation page 53a of the communication group 2 in response to a message viewing operation performed on the communication group 2. The authorization prompt information is: a group owner (the user a) has been bound to a super group (that is, a social group channel). The social group channel includes communication groups of platforms such as an application program 1 and an application program 2 (that is, channel description information). Group messages sent by the group owner in the communication groups are synchronized to the communication group 2. A group message sent in the communication group 2 may also be synchronized to the social group channel and other communication groups (that is, the message synchronization prompt information). The terminal b hides the authorization prompt message in the conversation page 53a in response to a trigger operation 5 performed on the confirmation option 54a, and determines that the user a allows the message sent by the user a to be synchronized in the social group channel and the communication group. The terminal b may return an authorization permission message to the terminal a. That is, when the user b sends a group message in the communication group 2, the group message is synchronized to the social group channel 51a and another communication group in the social group channel. When the user b sends a channel message in the social group channel 51a, the channel message is synchronized to all communication groups in the social group channel.

The terminal may present the group messages from the M communication groups and the channel message from the social group channel in the channel conversation page of the social group channel. In particular, the channel conversation page may further include a first message selection option, and the first message selection option is configured for selecting some messages from the channel conversation page for display. A group message of a communication group (or a communication group in an application program) or the channel message of the social group channel may be displayed in the channel conversation page by using the first message selection option. For example, the terminal displays the social group channel and the M communication groups in the channel conversation page in response to a trigger operation performed on the first message selection option, and displays, in the channel conversation page in response to a selection operation performed on the social group channel, channel messages transmitted in the social group channel by objects in the social group channel. A group message that is transmitted in a target communication group by an object in the target communication group is displayed in the channel conversation page in response to a selection operation performed on the target communication group of the M communication groups. Alternatively, the terminal displays, in the channel conversation page in response to a trigger operation performed on the first message selection option, the main application program of the social group channel and application programs corresponding to the M communication groups, and displays, in the channel conversation page in response to a selection operation performed on the main application program of the social group channel, channel messages transmitted in the social group channel by objects in the social group channel. A group message of a communication group included in a target application program of the application programs corresponding to the M communication groups is displayed in the channel conversation page in response to a selection operation performed on the target application program.

Similarly, the group conversation pages respectively corresponding to the M communication groups may further include a second message selection option. The second message selection option is used for selecting some messages from the group conversation page for display. A group message of a communication group (or a communication group in an application program) or the channel message of the social group channel may be displayed in the group conversation page by using the second message selection option. For example, the terminal displays the social group channel and the M communication groups in the group conversation page in response to a trigger operation performed on the second message selection option, and displays, in the group conversation page in response to a selection operation performed on the social group channel, channel messages transmitted in the social group channel by objects in the social group channel. A group message that is transmitted in a target communication group by an object in the target communication group is displayed in the group conversation page in response to a selection operation performed on the target communication group of the M communication groups. Alternatively, the terminal displays, in the group conversation page in response to a trigger operation performed on the second message selection option, the main application program of the social group channel and application programs corresponding to the M communication groups, and displays, in the group conversation page in response to a selection operation performed on the main application program of the social group channel, channel messages transmitted in the social group channel by objects in the social group channel. A group message of a communication group included in a target application program of the application programs corresponding to the M communication groups is displayed in the group conversation page in response to a selection operation performed on the target application program. The first message selection option and the second message selection option may be at least one of a text, a symbol, or a graphic.

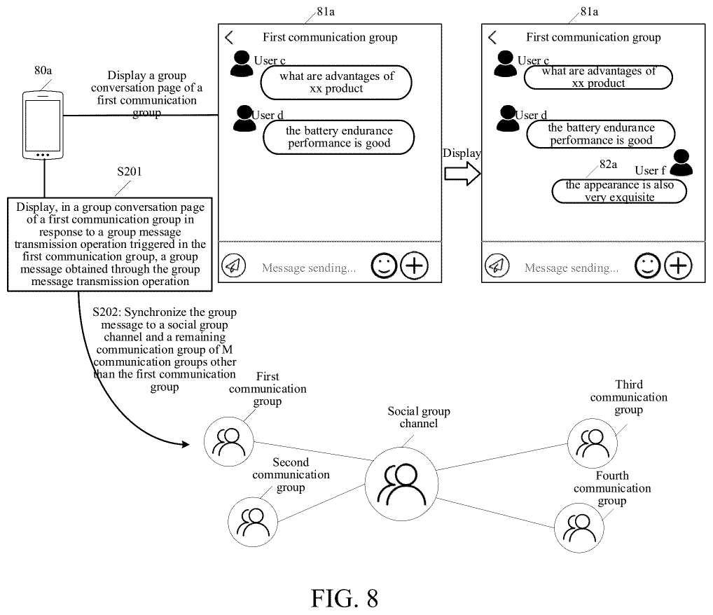

Further, FIG. 8 is a schematic flowchart of a type of message synchronization method according to an embodiment of the present disclosure. As shown in FIG. 8, the method may be performed by any terminal in FIG. 1, and a terminal configured to perform the method may be a target terminal. The method may include the following operations:

S201: Display, in a group conversation page of a first communication group in response to a group message transmission operation triggered in the first communication group, a group message obtained through the group message transmission operation. The first communication group is one of M communication groups corresponding to a social group channel, the social group channel is a group organization generated by associating the M communication groups, and M is an integer greater than or equal to 2.

In the present disclosure, if any object in the social group channel sends a group message in a communication group corresponding to the object, the group message is also synchronized to the social group channel and other communication groups. For example, a target object in the first communication group sends a message. The target object may be any object that belongs to the first communication group in the social group channel. The group message may be a session message, a file, a group announcement, a group activity, or the like. Specifically, all terminals corresponding to objects in the social group channel may display, in the group conversation page of the first communication group in response to the group message transmission operation performed on the first communication group, the group message carried in the group message transmission operation. That is, any object in the social group channel can view the group message in the conversation page of the social group channel, thereby implementing unified management of communication groups in different application programs through the social group channel.

For example, as shown in FIG. 8, the social group channel is obtained by associating a first communication group, a second communication group, a third communication group, and a fourth communication group. A user f is used as an example. The user f belongs to the first communication group and the second communication group of the M communication groups, the first communication group further includes a user c, and the second communication group further includes a user d. Certainly, the first communication group and the second communication group further include other objects, which are not described one by one herein. A terminal 80a corresponding to the user f may display a group conversation page 81a of the first communication group. History messages are displayed in the group conversation page 81a. The history messages include a third history message sent by the user c (that is, what are advantages of xx product?) and a fourth history message sent by the user d (that is, the battery endurance performance is good). The third history message may be sent by the user c in the first communication group or the social group channel, and the fourth history message may be sent by the user d in the second communication group or the social group channel. After the user f enters a group message in the group conversation page 81a, the terminal 80a obtains, in response to a group message transmission operation performed on the first communication group, a group message 82a (that is, the appearance is also very exquisite) entered by the user f in the group conversation page 81a, and displays the group message 82a in the group conversation page 81a. Further, the terminal 80a may synchronize the group message 82a to a terminal corresponding to an object other than the user f in the first communication group, and synchronize the group message 82a to the second communication group, the third communication group, and the fourth communication group.

In the present disclosure, the M communication groups may belong to the same application program or may belong to K application programs, where K is a positive integer greater than 1 and less than or equal to M. That is, at least two communication groups of the M communication groups belong to different application programs. There is an association relationship between the M communication groups. For related descriptions of the M communication groups and the social group channel, reference may be made to the foregoing Embodiment 2. Repeated details are not described herein again.

In some embodiments, operation S201 may include: displaying, by a target terminal, the group message in the group conversation page of the first communication group in response to the group message transmission operation triggered in the first communication group. Further, the group message is synchronized to a service backend corresponding to the first communication group. The service backend may synchronize the group message to all remaining objects in the first communication group other than the target object. The target object is an object that initiates the group message transmission operation in the first communication group. The group message is displayed in a group conversation page corresponding to the first communication group corresponding to all the remaining objects.

In some embodiments, the displaying, in response to a group message transmission operation triggered in the first communication group, a group message in a group conversation page corresponding to a first communication group corresponding to a target object includes: displaying, by a target terminal in the group conversation page of the first communication group in response to the group message transmission operation performed on the first communication group, a group aggregated message including the group message. The group aggregated message is obtained by aggregating the group message and a to-be-displayed group message that is to be displayed in the first communication group. The group aggregated message is obtained by aggregating the group message and a to-be-displayed group message that is to be displayed in the first communication group, and the to-be-displayed group message is at least one of a channel message sent in the social group channel and a group message sent in the remaining communication group. In other words, the first communication group can not only display the channel message transmitted in the social group channel by the object in the social group channel, but also display the group message transmitted in the M communication groups by the object in the social group channel, thereby implementing the interconnection between the social group channel and the communication groups and the interconnection between the communication groups and improving the message synchronization efficiency. In addition, messages displayed in the M communication groups can be kept the same as messages displayed in the social group channel, and continuity and readability of message context in the M communication groups and the social group channel can be improved.

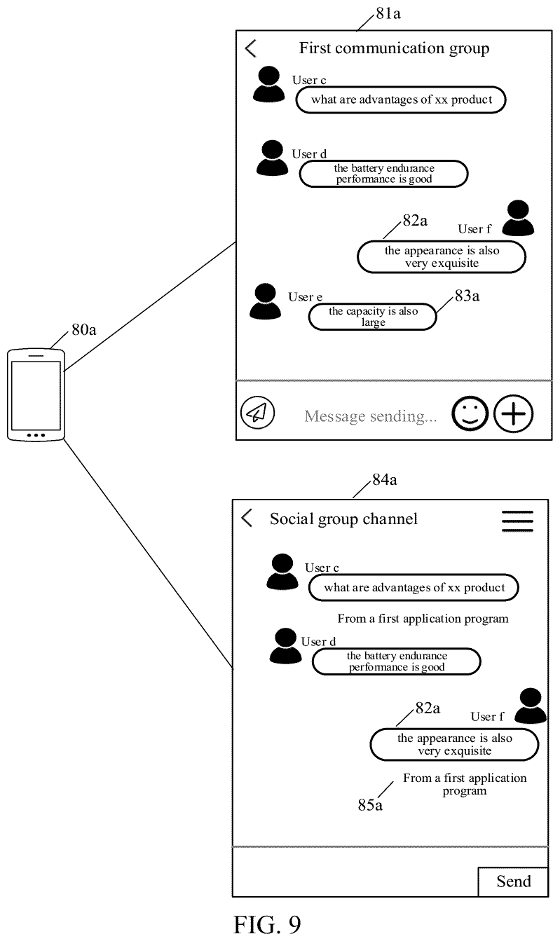

For example, referring to FIG. 8 and FIG. 9, the first communication group in FIG. 9 belongs to the first application program. The terminal 80a may display a group aggregated message in the conversation page 81a of the first communication group. The group aggregated message includes the group message 82a and a to-be-displayed group message 83a (that is, the capacity is also large). The to-be-displayed group message is sent by a user e in a remaining communication group or the social group channel. A transmission time of the group message 82a is earlier than a transmission time of the to-be-displayed group message 83a.

The group aggregated message may be returned by a service backend corresponding to the first application program corresponding to the first communication group. The service backend may periodically (for example, every 10 s or when there is a viewing requirement) obtain the to-be-displayed group message from a node corresponding to another application program (for example, the main application program corresponding to the social group channel and the application program corresponding to the remaining communication group), and aggregate the group message and the to-be-displayed group message. In this way, messages are returned to the target terminal in batches, frequent message return to the target terminal can be avoided, and message transmission overheads can be reduced.

S202: Synchronize the group message to the social group channel and a remaining communication group of the M communication groups other than the first communication group.

In the present disclosure, a target terminal may synchronize the group message to the social group channel and the remaining communication group of the M communication groups other than the first communication group. Any object in the social group channel and the remaining communication group can view the group message through the channel conversation page corresponding to the social group channel, thereby improving message sending efficiency. That is, messages displayed in the social group channel and the remaining communication group are the same, to ensure continuity and readability of message context in the social group channel and the remaining communication group.

In some embodiments, when the M communication groups belong to K application programs and K is an integer greater than 1 and less than M, it indicates that at least two communication groups of the M communication groups belong to different application programs. Message synchronization between the social group channel and the communication group is implemented through the social group channel, and message synchronization between communication groups in different application programs is implemented, so that message synchronization is implemented across platforms (different application programs). Besides, interconnection between the plurality of application programs is also implemented through one social group channel, thereby avoiding overheads caused by switching between the plurality of application programs to synchronize a plurality of messages. When the M communication groups all belong to one application program, the plurality of communication groups are interconnected by using the social group channel, to implement message synchronization in the plurality of communication groups and message synchronization between the plurality of communication groups by using the same social group channel, thereby avoiding overheads caused by switching between conversation pages of the plurality of communication groups to synchronize a plurality of messages.

After receiving the group message, the target terminal may display, in the channel conversation page of the social group channel in response to a message viewing operation performed on the social group channel, a channel aggregated message that includes the group message. The channel aggregated message is obtained by aggregating the group message and the to-be-displayed channel message that is to be displayed in the social group channel, and the to-be-displayed channel message is at least one of a channel message sent in the social group channel by an object in the social group channel and a group message sent in the remaining communication group by an object in the remaining communication group. In other words, the social group channel not only displays the channel message transmitted in the social group channel by the object in the social group channel, but also displays the group message transmitted in the M communication groups by the object in the social group channel, thereby implementing the interconnection between the social group channel and the communication groups and improving the message synchronization efficiency. In addition, it can be further ensured that messages in the social group channel are the same as those in the communication groups, so that message context in the social group channel and the communication groups remains continuous and readable.

The channel aggregated message may be returned by a service backend corresponding to the main application program corresponding to the social group channel. The service backend may periodically (for example, every 10 s or when there is a viewing requirement) obtain the to-be-displayed channel message from a node corresponding to another application program (the main application program and the application program corresponding to the remaining communication group), and aggregate the group message and the to-be-displayed channel message. In this way, messages are returned to the target terminal in batches, frequent message return to the target terminal can be avoided, and message transmission overheads can be reduced.

In some embodiments, the target terminal may display the group message and source information of the group message in a channel conversation page of a target object in the social group channel in response to a message viewing operation performed on the social group channel. The source information of the group message indicates that the group message comes from the first communication group. The source information of the group message may include a program identifier of the first application program corresponding to the first communication group. The program identifier may be at least one of a text, a graphic, or a symbol. The target object is an object that initiates the group message transmission operation. In other words, when the to-be-displayed message in the social group channel does not come from the main application program corresponding to the social group channel (that is, the to-be-displayed message is not sent in the social group channel), the source information of the to-be-displayed message may be displayed in the social group channel.

For example, referring to FIG. 8 and FIG. 9, a third history message is sent by the user c in the first communication group and a fourth history message is sent by the user d in the social group channel in FIG. 8. An application program to which the first communication group belongs is a first application program, an application program to which the second communication group belongs is a second application program, the social group channel belongs to a main application program, and the main application program is different from the first application program and the second application program. The terminal 80a corresponding to the user f may display the group message 82a and the source information 85a (that is, from the first application program) of the group message 82a in the channel conversation page 84a of the social group channel in response to a message viewing operation performed on the social group channel. The source message 85a is configured for prompting that the group message 82a comes from the first application program corresponding to the first communication group, that is, the group message 82a is sent in the first communication group by an object in the first communication group. It can be learned from source information (that is, from the first application program) of the third history message in FIG. 9 that the third history message is sent by the user c in the first communication group. Source information of the fourth history message is not displayed in the channel conversation page 84a of the social group channel, and it indicates that the fourth history message comes from the main application program corresponding to the social group channel.

The displaying the group message in a channel conversation page of a target object in the social group channel in response to a message viewing operation performed on the social group channel includes: displaying, by the target terminal in a session home page of the channel application program of the social group channel, prompt information prompting that the social group channel has a to-be-viewed message, where the session home page may be a page displayed after the main application program corresponding to the social group channel is started, and the prompt message may be at least one of a text, a graphic, a symbol, and the like. The target terminal may update the session home page to the channel conversation page of the target object in the social group channel in response to the trigger operation performed on the prompt information. Further, the channel message carried in the group message transmission operation is displayed in the channel conversation page of the target object in the social group channel. The prompt information is displayed in the session home page, so that a weak message prompt is implemented, and the user is not disturbed.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When an object in the social group sends a group message in the M communication groups, the group message is synchronized to the social group channel and another communication group, to implement message synchronization between the communication group and the social group channel, and also implement message synchronization between different communication groups. In a message sending process, there is no need to switch between the channel conversation page and a group conversation page of the communication group, thereby simplifying a message sending process and improving message sending efficiency.

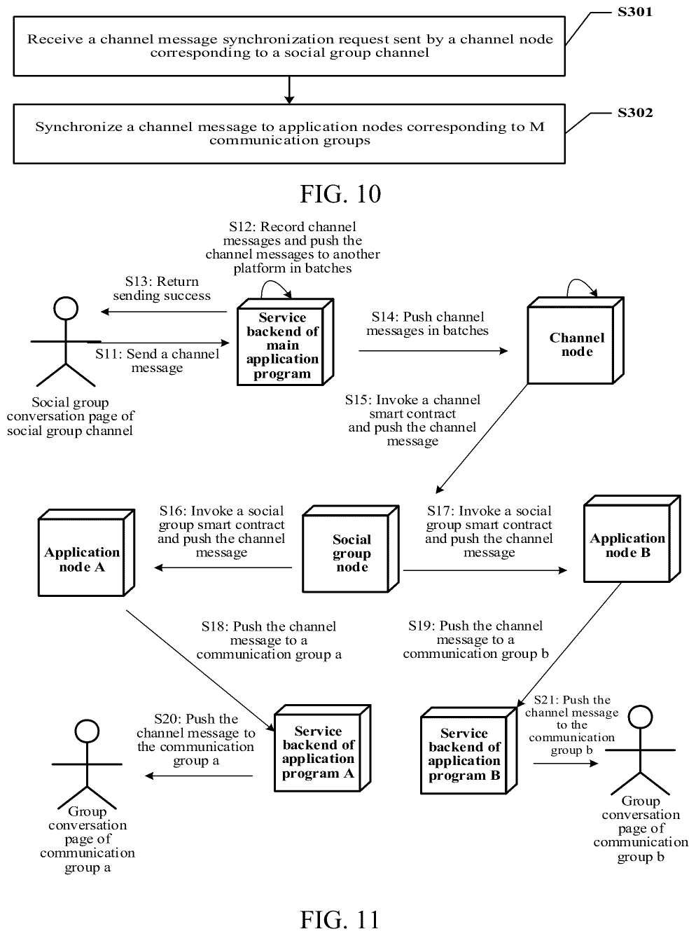

Further, FIG. 10 is a schematic flowchart of a type of message synchronization method according to an embodiment of the present disclosure. As shown in FIG. 10, the method may be performed by the social group node in FIG. 1. The method may include the following operations:

S301: Receive a channel message synchronization request sent by a channel node corresponding to a social group channel. The channel message synchronization request carries a channel message; the channel message is transmitted in the social group channel by an object in the social group channel; the social group channel is a group organization generated by associating the M communication groups; and M is an integer greater than or equal to 2.

In the present disclosure, after transmitting the channel message in the social group channel, a target terminal may send the channel message to a service backend of a main application program corresponding to the social group channel, the service backend may send the channel message to the channel node corresponding to the social group channel, and the channel node may generate the channel message synchronization request and send the channel message synchronization request to a social group node.

S302: Synchronize the channel message to application nodes corresponding to the M communication groups. The application nodes corresponding to the M communication groups are configured to synchronize the channel message to the M communication groups.

In the present disclosure, after receiving the channel message synchronization request, the social group node may send the channel message to the application nodes corresponding to the M communication groups, the application nodes corresponding to the M communication groups send the channel message to service backends of the application programs corresponding to the M communication groups, and the service backends send the channel message to terminals corresponding to objects in the M communication groups.

The channel node, a social group node that receives the channel message synchronization request, and K application nodes are consortium members satisfying a consortium communication protocol (e.g., all of the consortium members that satisfy a consortium communication protocol. One of the K application nodes corresponds to one of K application programs. That is, the channel node, the social group node that receives the channel message synchronization request, and the K application nodes may be consortium members in the consortium blockchain network. The consortium communication protocol specifies communication channels, the channel smart contract, and the group smart contract of all the nodes in the consortium blockchain network, and records the relationship chain list of the social group channel and a message synchronization rule. The consortium communication protocol is jointly formulated by the nodes in the consortium blockchain network and is jointly followed. The message synchronization rule may include a message encapsulation format, a message synchronization manner, and the like for message synchronization. The message synchronization manner may be how to synchronize a group message to the social group channel, and how to synchronize a channel message to a communication group. The channel smart contract is recorded in the channel node, and the group smart contract is recorded in the application node. The channel smart contract records a service that the channel node needs to provide, for example, how to synchronize a channel message to a communication group, and records the relationship chain of the social group channel. The group smart contract records a service that an application node needs to provide, for example, how to synchronize a group message to the social group channel, and records a relationship chain in a communication group. The relationship chain list records a list of relationship chains of objects in the social group channel on various application programs. K is an integer greater than 1 and less than M.

In some embodiments, the M communication groups include a first communication group, and operation S302 may include: obtaining, by a social group node from the consortium communication protocol, a relationship chain list and a first relationship chain that corresponds to the social group channel; where the first relationship chain includes a mapping relationship between an object channel identifier that is of an object in the social group channel and that is in the social group channel (in a main application program) and a digital identifier of the object in the social group channel; and the first communication group is any one of the M communication groups; mapping, by the social group node according to the relationship chain list, the first relationship chain to a second relationship chain corresponding to the first communication group, that is, according to a digital identifier of any object in the first relationship chain, querying a relationship chain of the object in the first communication group as a second relationship chain from the relationship chain list, where the relationship chain list includes a relationship chain that is of at least two objects in a communication group and that is in the corresponding communication group, and a relationship chain that is of at least one object in the social group channel and that is in the social group channel, and the second relationship chain includes a mapping relationship between an object group identifier that is of an object in the first communication group and that is in the first communication group (that is, in the application program corresponding to the first communication group) and a digital identifier of the object in the first communication group, for example, the social group node may compare the first relationship chain with a relationship chain corresponding to a communication group in the relationship chain list, to obtain a relationship chain having the same digital identifier as that in the first relationship chain, and determine the relationship chain having the same digital identifier in the relationship chain list as the second relationship chain; and sending, by the social group node, the second relationship chain and the channel message to a first application node corresponding to an application program to which the first communication group belongs. The first application node is configured to synchronize the channel messages to the first communication group according to the second relationship chain. Through interaction between the social group node and the first application node, the channel message can be synchronized to the first communication group, that is, interconnection between the social group channel and the communication group can be implemented.

The social group node may obtain a first mapping relationship between an object channel identifier and a digital identifier of a sender of the channel message, convert the first mapping relationship into a second mapping relationship, and send the second mapping relationship, the second relationship chain, and the channel message to the first application node corresponding to the application program to which the first communication group belongs. The second mapping relationship indicates a mapping relationship between an object group identifier of the sender of the channel message in the first communication group and the digital identifier, and indicates the sender of the channel message. After receiving the channel message, a terminal corresponding to an object in the first communication group may display the object group identifier of the sender in the first communication group and the channel message in the group conversation page corresponding to the first communication group.

An object g in the social group channel does not belong to the first communication group, and an object group identifier of the object g in the first communication group may be an object channel identifier of the object g in the social group channel, or the object group identifier may be randomly generated. That is, the object g is not added to a member list of the first communication group, but messages of the object g can be synchronized to the first communication group without modifying the application program corresponding to the first communication group.

For example, as shown in FIG. 11, the social group channel is obtained by associating a communication group a with a communication group b. The communication group a belongs to an application program A, the communication group b belongs to an application program B, and the social group channel belongs to a main application program. The main application program is different from the application program A and the application program B. An application node A corresponding to the application program A, an application node B corresponding to the application program B, the channel node corresponding to the social group channel, and the social group node corresponding to the main application program are consortium members satisfying the consortium communication protocol. That is, the application node A, the application node B, the channel node, and the social group node form the blockchain network. Each node stores a corresponding smart contract, and the smart contract indicates a service that a corresponding node needs to provide. The channel node stores a channel smart contract, and the channel smart contract indicates how the channel node synchronizes the channel message to a communication group, records a relationship chain in the social group channel, and the like. The application node A includes a smart contract A (that is, a group smart contract), and the smart contract is used for indicating how the application node A synchronizes a group message to the social group channel and a communication group of another platform, recording a relationship chain in the communication group in the application program A, and the like. The application node B includes a smart contract B (that is, a group smart contract), and the smart contract is used for indicating how the application node B synchronizes a group message to the social group channel and a communication group of another platform, recording a relationship chain in the communication group in the application program B, and the like. The social group node stores a social group smart contract, and the social group smart contract indicates how the social group node maps mapping relationships in different platforms and the like.

Further, when an object in the social group channel sends a channel message in the channel conversation page corresponding to the social group channel, the node may synchronize the channel message to a third-party application program (that is, the application program A and the application program B). As shown in FIG. 11, a specific implementation process includes: S11: Send a channel message. Each target object in the social group channel may send the channel message in the channel conversation page. The target object may be any object in the social group channel, and the target object may belong to a communication group a or a communication group b. When the target object sends the channel message in the channel conversation page, a terminal corresponding to the target object may obtain the channel message, and send the channel message to the service background of the main application program. S12: Record channel messages and push the channel messages to another platform in batches. After receiving the channel messages, the service background of the main application program may record the channel messages in a local storage of the service background of the main application program, so that the channel messages may be synchronized to the another platform in batches. The another platform herein is the application program A and the application program B. S13: Return sending success. After receiving the channel message, the service backend of the main application program may return a message transmission success notification to the terminal corresponding to the object in the social group channel, and the terminal corresponding to the object in the social group channel may display the channel message in the channel conversation page. S14: Push the channel messages to a channel node in batches. The service backend of the main application program may continuously obtain channel messages sent by the objects in the social group channel, and push the channel messages to the channel node in batches. For example, when a quantity of to-be-synchronized channel messages reaches a quantity threshold, the service backend of the main application program may push the channel messages to the channel node in batches. Alternatively, the service backend of the main application program may push channel messages to the channel node in batches every preset duration. S15: Invoke a channel smart contract to push the channel message to a social group node. The channel node may invoke the channel smart contract, encapsulate the channel message, information of the sender of the channel message, the channel identifier of the social group channel, and the like according to a channel message encapsulation format, to obtain the channel message in the channel message format, and synchronize the channel message in the channel message encapsulation format to the social group node. S16: Invoke a social group smart contract to push the channel message to an application node A. The social group node may invoke a group smart contract, and obtain a relationship chain 1 and a relationship chain list from the consortium communication protocol based on the channel identifier. The relationship chain 1 is a mapping relationship between an object channel identifier that is of an object in the social group channel and that is in the main application program and a digital identifier. The relationship chain 1 is mapped to a relationship chain 2 based on the relationship chain list. The relationship chain 2 indicates a mapping relationship between a group identifier that is of an object in the communication group a and that is in the communication group a and a digital identifier. The relationship chain 2 and the channel message are sent to the application node A. S17: Invoke a social group smart contract to push the channel message to an application node B. The social group node may invoke a group smart contract, and map the relationship chain 1 to a relationship chain 3 based on the relationship chain list. The relationship chain 3 indicates a mapping relationship between a group identifier that is of an object in the communication group b and that is in the communication group b and a digital identifier. The relationship chain 3 and the channel message are sent to the application node B. S18: Push the channel message to the communication group b. The application node A may convert the message encapsulation format of the channel message into a group message encapsulation format corresponding to the application program A, and send the channel message in the group message encapsulation format A and the relationship chain 2 to a service background of the application program A. S19: Push the channel message to the communication group b. The application node B may convert the message encapsulation format of the channel message into a group message encapsulation format corresponding to the application program B, and send the channel message in the group message encapsulation format B and the relationship chain 3 to a service background of the application program B. S20: Push the channel message to the communication group a. After receiving the relationship chain 2, the service backend of the application program A determines, based on the mapping relationship between a relationship chain and a communication group, that the channel message needs to be synchronized to the communication group a, and may decapsulate the channel message in the group message encapsulation format A to obtain the channel message, the information of the sender, and the like, and send the channel message and the information of the sender to a terminal corresponding to an object in the communication group a, so that the terminal corresponding to the object in the communication group a may display the channel message in a group conversation page of the communication group a. S21: Push the channel message to the communication group b. After receiving the relationship chain 3, the service backend of the application program B determines, based on the mapping relationship between a relationship chain and a communication group, that the channel message needs to be synchronized to the communication group b, and may decapsulate the channel message in the group message encapsulation format B to obtain the channel message, the information of the sender, and the like, and send the channel message and the information of the sender to a terminal corresponding to an object in the communication group b, so that the terminal corresponding to the object in the communication group b may display the channel message in a group conversation page of the communication group b.

The sending the second relationship chain and the channel message to a first application node corresponding to an application program to which the first communication group belongs includes: obtaining, by the social group node, a to-be-displayed group message from an application node corresponding to a remaining communication group; where the remaining communication group is a communication group of the M communication groups other than the first communication group; the to-be-displayed group message is a message that is sent in the remaining communication group by an object in the social group channel and that is to be displayed (that is, not displayed yet) in the first communication group; aggregating, by the social group node, the channel message and the to-be-displayed group message to obtain a candidate group aggregated message, for example, sorting the channel message and the to-be-displayed group message that corresponds to the same object according to a transmission time, to obtain the candidate group aggregated message; and sending, by the social group node, the candidate group aggregated message and the second relationship chain to the first application node corresponding to the application program to which the first communication group belongs. The first application node is configured to synchronize the group aggregated message to the first communication group. The group aggregated message is obtained by aggregating the candidate group aggregated message and the to-be-displayed group message that is transmitted in the first communication group by the object in the first communication group. The to-be-displayed group message may be periodically obtained by the social group node from at least one of the application node corresponding to the second communication group and the channel node, which helps feed back messages to the terminal in batches and save message sending resources. When the M communication groups belong to K application programs and K is an integer greater than 1 and less than M, it indicates that at least two communication groups of the M communication groups belong to different application programs. Message synchronization between the social group channel and the communication group is implemented through the social group channel, and message synchronization between communication groups in different application programs is implemented, so that message synchronization is implemented across platforms (different application programs). Besides, interconnection between the plurality of application programs is also implemented through one social group channel, thereby avoiding overheads caused by switching between the plurality of application programs to synchronize a plurality of messages. When the M communication groups all belong to one application program, the plurality of communication groups are interconnected by using the social group channel, to implement message synchronization in the plurality of communication groups and message synchronization between the plurality of communication groups by using the same social group channel, thereby avoiding overheads caused by switching between conversation pages of the plurality of communication groups to synchronize a plurality of messages.

In the present disclosure, through interaction among the social group node, the channel node, and the application node, the channel message in the social group channel is synchronized to the communication groups, and unified management of the M communication groups is implemented by using the social group channel.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel sends a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

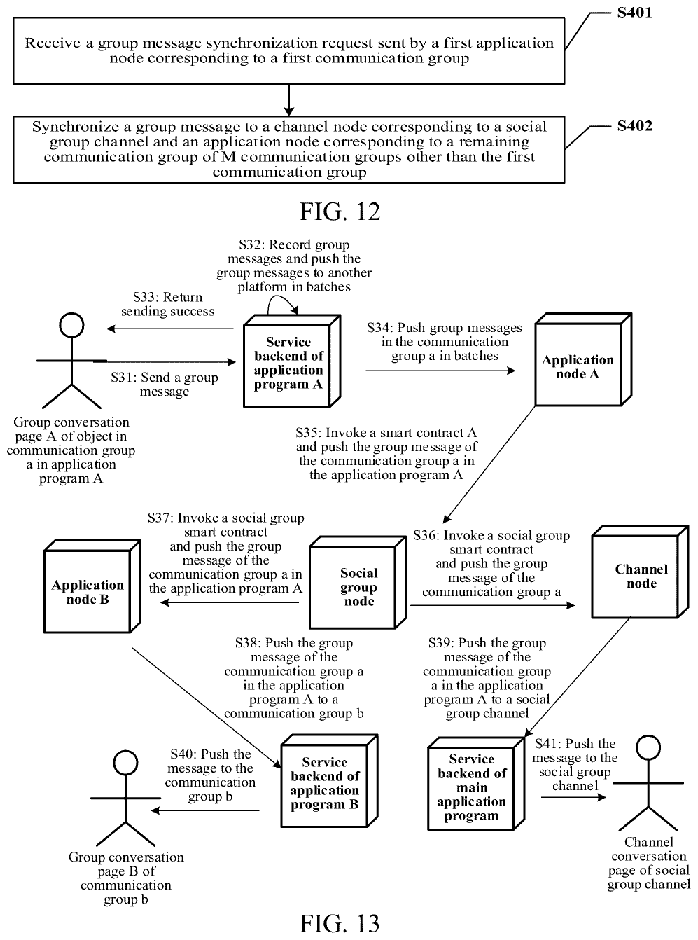

Further, FIG. 12 is a schematic flowchart of a type of message synchronization method according to an embodiment of the present disclosure. As shown in FIG. 12, the method may be performed by the social group node in FIG. 1. The method may include the following operations:

S401: Receive a group message synchronization request sent by a first application node corresponding to a first communication group. The group message synchronization request carries a group message transmitted by a target object in the first communication group of a first application program, the first communication group is one of M communication groups corresponding to a social group channel, the social group channel is a group organization generated after associating the M communication groups, the target object is an object in the first communication group, and M is an integer greater than or equal to 2. In the present disclosure, after a target object corresponding to a target terminal sends a group message in the first communication group, the target terminal may send the group message to a service backend of a first application program corresponding to the first communication group, the service backend may send the group message to a first application node corresponding to the first application program, and the first application node may generate a group message synchronization request and send the group message synchronization request to a social group node.

The M communication groups may belong to the same application program or may belong to K application programs, where K is a positive integer greater than 1 and less than or equal to M. That is, at least two communication groups of the M communication groups belong to different application programs. There is an association relationship between the M communication groups. For related descriptions of the M communication groups and the social group channel, reference may be made to the foregoing Embodiment 2. Repeated details are not described herein again.

S402: Synchronize the group message to a channel node corresponding to the social group channel and an application node corresponding to a remaining communication group of the M communication groups other than the first communication group. The channel node is configured to synchronize the group message to the social group channel, and the application node corresponding to the remaining communication group is configured to synchronize the group message to the remaining communication group.

In the present disclosure, after receiving the group message synchronization request, the social group node may synchronize the group message carried in the group message synchronization request to a channel node corresponding to the social group channel and an application node corresponding to a remaining communication group of the M communication groups other than the first communication group. The channel node is configured to synchronize the group message to the social group channel, that is, the channel node synchronizes the group message to the service backend of the main application program, and the service backend sends the group message to a terminal corresponding to an object in the social group channel. Through interaction among the social group node, the application node, and the channel node, message synchronization between the social group channel and the communication group is implemented, and message synchronization between the communication groups is implemented.

In some embodiments, the channel node, a social group node that receives the group message synchronization request, and K application nodes are consortium members satisfying a consortium communication protocol. One of the K application nodes corresponds to one of K application programs. That is, the channel node, the social group node that receives the channel message synchronization request, and the K application nodes may be consortium members in the consortium blockchain network. The consortium communication protocol specifies communication channels, the channel smart contract, and the group smart contract of all the nodes in the consortium blockchain network, and records the relationship chain list of the social group channel and a message synchronization rule. The consortium communication protocol is jointly formulated by the nodes in the consortium blockchain network and is jointly followed. The message synchronization rule may include a message encapsulation format, a message synchronization manner, and the like for message synchronization. The message synchronization manner may be how to synchronize a group message to the social group channel, and how to synchronize a channel message to a communication group. The channel smart contract is recorded in the channel node, and the group smart contract is recorded in the application node. The channel smart contract records a service that the channel node needs to provide, for example, how to synchronize a channel message to a communication group, and records the relationship chain of the social group channel. The group smart contract records a service that an application node needs to provide, for example, how to synchronize a group message to the social group channel, and records a relationship chain in a communication group. The relationship chain list records a list of relationship chains that are of objects in the social group channel and that are in various application programs.

In some embodiments, the synchronizing the group message to a channel node corresponding to the social group channel includes: obtaining, by the social group node from the consortium communication protocol, a relationship chain list and a second relationship chain that corresponds to the first communication group, where the relationship chain list includes relationship chains that are of objects in communication groups and that are in the corresponding communication groups, and a relationship chain that is of an object in the social group channel and that is in the social group channel, and the second relationship chain includes a mapping relationship between an object group identifier that is of an object in the first communication group and that is in the first communication group (that is, in the application program corresponding to the first communication group) and a digital identifier of the object in the first communication group; according to a digital identifier of an object in the second relationship chain, querying a relationship chain of the object in the second communication group as the first relationship chain from the relationship chain list, where the first relationship chain includes a mapping relationship between an object channel identifier that is of an object in the social group channel and that is in the social group channel (in a main application program) and a digital identifier of the object in the social group channel, for example, the social group node may compare the second relationship chain with a relationship chain corresponding to the social group channel in the relationship chain list, to obtain a relationship chain having the same digital identifier as that in the second relationship chain, and determine the relationship chain having the same digital identifier as that in the second relationship chain as the first relationship chain; and sending the first relationship chain and the group message to the channel node corresponding to the social group channel. The channel node is configured to synchronize the group message to the social group channel based on the first relationship chain, that is, the channel node sends the first relationship chain and the group message to a service backend corresponding to the social group channel, and the service backend sends the group message to a terminal corresponding to an object in the first relationship chain. Through interaction among the social group node, the channel node, and the application node, message interaction between the communication group and the social group channel is implemented.

The social group node may obtain the second mapping relationship between an object group identifier that is of the sender of the group message and that is in the first communication group and the digital identifier, convert the second mapping relationship into the first mapping relationship, and send the first mapping relationship, the first relationship chain, and the group message to the channel node corresponding to the social group channel. The first mapping relationship indicates a mapping relationship between the object channel identifier of the sender in the social group channel and the digital identifier, and indicates the sender of the group message. When receiving the group message, a terminal corresponding to an object in the social group channel may display the object channel identifier of the sender in the social group channel and the group message in the channel conversation page corresponding to the social group channel.

The transmitting the first relationship chain and the group message to the channel node corresponding to the social group channel includes: obtaining, by the social group node, a to-be-displayed channel message from the application node corresponding to the remaining communication group; where the to-be-displayed channel message is a message that is transmitted in the remaining communication group by an object in the social group channel and that is to be displayed in the social group channel; aggregating the to-be-displayed channel message corresponding to the remaining communication group and the group message to obtain a candidate channel aggregated message, for example, sorting the to-be-displayed channel messages corresponding to the M communication groups and the group message according to transmission times to obtain the candidate channel aggregated message; and transmitting, by the social group node, the candidate channel aggregated message and the first relationship chain to the channel node corresponding to the social group channel. The channel node is configured to synchronize the channel aggregated message to the social group channel; and the channel aggregated message is obtained by aggregating the candidate channel aggregated message and the to-be-displayed channel message transmitted in the social group channel by the object in the social group channel. The to-be-displayed channel messages corresponding to the M communication groups may be periodically obtained from the application nodes by the social group node, which helps feed back the messages to the terminal in batches and save message sending resources.

When the M communication groups belong to K application programs and K is an integer greater than 1 and less than M, it indicates that at least two communication groups of the M communication groups belong to different application programs. Message synchronization between the social group channel and the communication group is implemented through the social group channel, and message synchronization between communication groups in different application programs is implemented, so that message synchronization is implemented across platforms (different application programs). Besides, interconnection between the plurality of application programs is also implemented through one social group channel, thereby avoiding overheads caused by switching between the plurality of application programs to synchronize a plurality of messages. When the M communication groups all belong to one application program, the plurality of communication groups are interconnected by using the social group channel, to implement message synchronization in the plurality of communication groups and message synchronization between the plurality of communication groups by using the same social group channel, thereby avoiding overheads caused by switching between conversation pages of the plurality of communication groups to synchronize a plurality of messages.

Similarly, the synchronizing the group message to an application node corresponding to a remaining communication group of the M communication groups other than the first communication group includes: comparing, by the social group node, the second relationship chain with a relationship chain corresponding to a communication group in the relationship chain list, to obtain a relationship chain having the same digital identifier as that in the second relationship chain, and determining the relationship chain having the same digital identifier as that in the second relationship chain as a third relationship chain corresponding to the remaining communication group; and sending the third relationship chain and the group message to an application node corresponding to the remaining communication group, and sending, by the application node corresponding to the remaining communication group, the third relationship chain and the group message to a service backend corresponding to the remaining communication group. The service backend corresponding to the remaining communication group may send the group message to a terminal of an object in the remaining communication group, to implement message synchronization between communication groups and implement message synchronization across platforms. This avoids overheads caused by switching between a plurality of application programs to synchronize a plurality of messages, and improves message synchronization efficiency.

For example, referring to FIG. 11 and FIG. 13, when an object in the communication group a sends a group message in the group conversation page of the communication group a, the social group node, the channel node, and the application node in FIG. 13 may synchronize the group message to the social group channel and the communication group b. When an object in the communication group b sends a group message in the group conversation page of the communication group b, the social group node, the channel node, and the application node in FIG. 13 may synchronize the group message to the social group channel and the communication group b. As shown in FIG. 13, a specific implementation process includes: S31: Send a group message. For example, an object in the communication group a sends the group message in a group conversation page of the communication group a. When the object in the communication group a sends the group message in the group conversation page, a terminal corresponding to the object in the communication group a may obtain the group message, and send the group message to a service background of the application program A. S32: Record group messages and push the group messages to another platform in batches. After receiving the group messages, the service background of the application program A may record the group messages in a local storage of the service background of the application program A, so that the group messages may be synchronized to the another platform in batches. The another platform herein is the main application program and the application program B. S33: Return sending success. After receiving the group message, the service backend of the application program A may return a message transmission success notification to the terminal corresponding to the object in the communication group a. The terminal corresponding to the object in the communication group a may display the group message in the conversation page of the communication group a. S34: Push the group messages in the communication group a in batches. The service backend of the application program A may continuously obtain group messages sent by the objects in the communication group a, and push the group messages to the application node A in batches. For example, when a quantity of to-be-synchronized group messages reaches a quantity threshold, the service backend of the application program A may push the group messages to the application node A in batches. Alternatively, the service background of the application program A may push group messages to the application node A in batches every preset duration.

S35: Invoke a smart contract A to push the group message of the communication group a in the application program A to the social group node. The application node A may invoke the smart contract A, encapsulate the group message, the information of the sender of the group message, the group identifier of the communication group a, and the like according to the group message encapsulation format of the application program A, to obtain the group message in the group message encapsulation format of the application program A, and synchronize the group message in the group message encapsulation format of the application program A to the social group node. S36: Invoke a social group smart contract to push the group message of the communication group a to the channel node. The social group node may invoke a group smart contract, and obtain a relationship chain 2 (that is, the relationship chain 2 in FIG. 11) and a relationship chain list from the consortium communication protocol based on the group identifier. The relationship chain 2 indicates a mapping relationship between an object group identifier that is of an object in the communication group a and that is in the application program A and a digital identifier. The relationship chain 2 is mapped to a relationship chain 1 based on the relationship chain list. The relationship chain 1 indicates a mapping relationship between an object channel identifier of an object in the social group channel and a digital identifier. The relationship chain 1 and the group message are sent to the channel node. S37: Invoke a smart contract B to push the group message of the communication group a in the application program A to the application node B. The social group node may invoke a group smart contract, and map the relationship chain 2 to a relationship chain 3 based on the relationship chain list. The relationship chain 3 indicates a mapping relationship between a group identifier that is of an object in the communication group b and that is in the communication group b and a digital identifier. The relationship chain 3 and the group message are sent to the application node B.

S38: Push the group message of the communication group a in the application program A to the communication group b. The channel node may convert the message encapsulation format of the group message into a group message encapsulation format B corresponding to the application program B, and send the group message in the group message encapsulation format B and the relationship chain 3 to a service background of the application program B. S39: Push the group message of the communication group a in the application program A to the social group channel. The channel node may convert the message encapsulation format of the group message into a channel message encapsulation format corresponding to the main application program, and send the group message in the channel message encapsulation format and the relationship chain 1 to a service background of the main application program. S40: Push the message to the communication group b. After receiving the relationship chain 3, the service backend of the application program B determines, based on the mapping relationship between a relationship chain and a communication group, that the group message needs to be synchronized to the communication group b, and may decapsulate the group message in the group message encapsulation format B, to obtain the group message, the information of the sender, and the like, and send the group message and the information of the sender to a terminal corresponding to an object in the communication group b, so that the terminal corresponding to the object in the communication group b may display the group message in a group conversation page of the communication group b. S41: Push the message to the social group channel. After receiving the relationship chain 1, the service backend of the main application program determines, based on the mapping relationship between a relationship chain and the social group channel, that the group message needs to be synchronized to the social group channel, and may decapsulate the group message in the group message encapsulation format B to obtain the group message, the information of the sender, and the like, and send the group message and the information of the sender to a terminal corresponding to an object in the social group channel, so that the terminal corresponding to the object in the social group channel may display the group message in a channel conversation page.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel sends a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

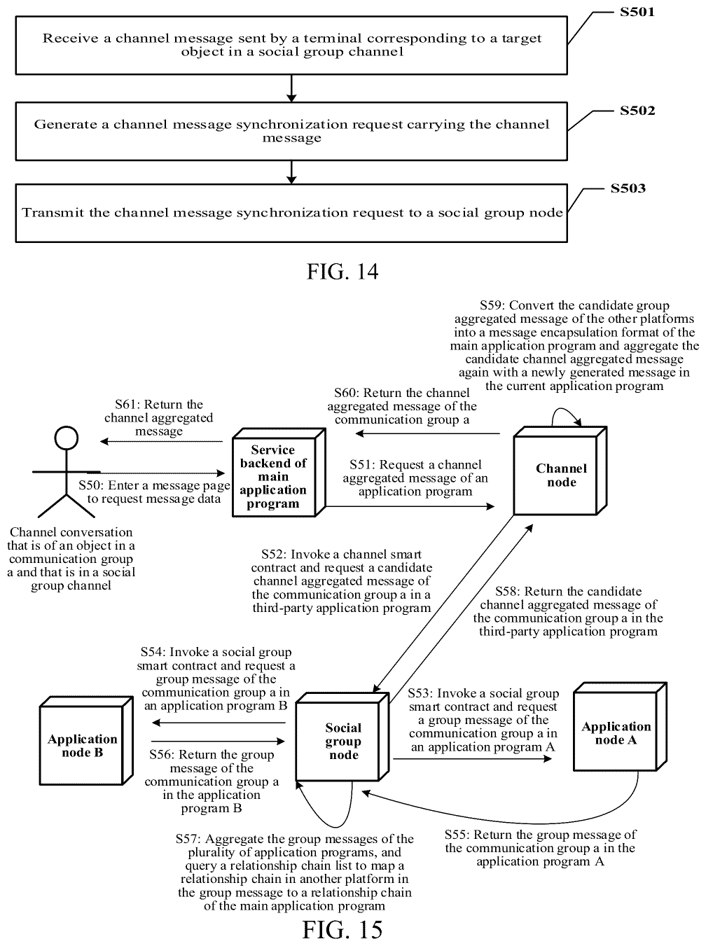

Further, FIG. 14 is a schematic flowchart of a type of message synchronization method according to an embodiment of the present disclosure. As shown in FIG. 14, the method may be performed by the channel node in FIG. 1. The method may include the following operations:

S501: Receive a channel message sent by a terminal corresponding to a target object in a social group channel. The channel message is transmitted by the target object in the social group channel; the social group channel is a group organization generated by associating the M communication groups; and M is an integer greater than or equal to 2, and the target object belongs to at least one communication group of the M communication groups.

In the present disclosure, after the target object corresponding to the target terminal sends the channel message in the social group channel, the target terminal may send the channel message to the service backend of the main application program corresponding to the social group channel, and the channel node corresponding to the social group channel may obtain the channel message from the service backend in real time or periodically.

S502: Generate a channel message synchronization request carrying the channel message.

In the present disclosure, the channel node may generate the channel message synchronization request carrying the channel message, where the channel message synchronization request is used for indicating to synchronize the channel message to application nodes corresponding to the M communication groups.

The channel node, a social group node corresponding to the social group channel, and K application nodes are all consortium members satisfying a consortium communication protocol. One of the K application nodes corresponds to one of K application programs. That is, the channel node, the social group node, and the K application nodes may be consortium members in the consortium blockchain network. The consortium communication protocol specifies communication channels, the channel smart contract, and the group smart contract of all the nodes in the consortium blockchain network, and records the relationship chain list of the social group channel and a message synchronization rule. The consortium communication protocol is jointly formulated by the nodes in the consortium blockchain network and is jointly followed. The message synchronization rule may include a message encapsulation format, a message synchronization manner, and the like for message synchronization. The message synchronization manner may be how to synchronize a group message to the social group channel, and how to synchronize a channel message to a communication group. The channel smart contract is recorded in the channel node, and the group smart contract is recorded in the application node. The channel smart contract records a service that the channel node needs to provide, for example, how to synchronize a channel message to a communication group, and records the relationship chain of the social group channel. The group smart contract records a service that an application node needs to provide, for example, how to synchronize a group message to the social group channel, and records a relationship chain in a communication group. The relationship chain list records a list of relationship chains of objects in the social group channel on various application programs. K is an integer greater than 1 and less than or equal to M.

In operation 502, the consortium communication protocol may specify that message synchronization is performed in a common message encapsulation format. The common message encapsulation format may be a message encapsulation format uniformly used for message synchronization of the communication groups in the social group channel and the social group channel, that is, the common message encapsulation format may be a message encapsulation format supported by (compatible with) both each third-party application program and the main application program. The message encapsulation format supported by both each third-party application program and the main application program may mean that each third-party application program and the main application program both have a capability of decapsulating a message in the common message encapsulation format or encapsulating a message into the common message encapsulation format. The common message encapsulation format is recorded in the consortium communication protocol. The common message encapsulation format may be a message encapsulation format used by the main application program and the third-party application program to send messages. The message encapsulation format defines a message header and a message body. The message header includes a plurality of fields, for example, a sender field for writing information about a sender, and the message body is used for writing content of a message (for example, a channel message or a group message). Message headers corresponding to different message encapsulation formats can carry different amounts of data, and/or quantities of fields in message headers are different.

For example, when the consortium communication protocol specifies that message synchronization is performed in the common message encapsulation format, the channel node may obtain the common message encapsulation format from the consortium communication protocol. The channel node may encapsulate, according to the common message encapsulation format, the channel message, a channel identifier (for example, a serial number and a name) of the social group channel, a program identifier of the main application program, information of the sender of the channel message, and the like, to obtain the channel message in the common message encapsulation format. The channel message in the common message encapsulation format is determined as the channel message synchronization request carrying the channel message. In this case, after receiving the channel message in the common message encapsulation format, the application node corresponding to the communication group including the target object may directly send the channel message in the common message encapsulation format to terminals of objects in the communication group including the target object, without performing format conversion again. The terminals may display the channel message based on the common message encapsulation format of the channel message, and perform message synchronization by using the common message encapsulation format, thereby reducing message encapsulation format conversion and saving message processing resources.

In some embodiments, operation S502 includes: when the consortium communication protocol specifies that message synchronization is performed in a non-common message encapsulation format, that is, application programs interact with each other in their own message encapsulation formats, obtaining, by the channel node from the consortium communication protocol, a channel message encapsulation format corresponding to the social group channel, where the channel message encapsulation format is a message encapsulation format supported by the main application program corresponding to the social group channel; encapsulating the channel message, a channel identifier (for example, a serial number and a name) of the social group channel, a program identifier of the main application program, information of a sender of the channel message, and the like according to the channel message encapsulation format, to obtain a channel message in the channel message encapsulation format; and determining the channel message in the channel message encapsulation format as the channel message synchronization request carrying the channel message. In this case, after receiving the channel message in the channel message encapsulation format, the application node corresponding to the communication group including the target object may perform format conversion on the channel message in the channel message encapsulation format based on a group message encapsulation format corresponding to the communication group including the target object, to obtain the channel message in the group message encapsulation format. The channel message in the group message encapsulation format is sent to terminals of the objects in the communication group including the target object, and the terminals may read the channel message from the channel message in the group message encapsulation format, and display the channel message. The application node performs format conversion on the channel message in the channel message encapsulation format, thereby implementing message synchronization between different application programs and implementing interconnection between different application programs.

S503: Transmit the channel message synchronization request to a social group node. The social group node is configured to synchronize the channel message to the application nodes of the M communication groups according to the channel message synchronization request. The application nodes of the M communication groups are configured to synchronize the channel message to the M communication groups.

In the present disclosure, the channel node may send the channel message synchronization request to the social group node, the social group node is configured to synchronize, according to the channel message synchronization request, the channel message to the application nodes corresponding to the M communication groups, and the application node may synchronize the channel message to terminals corresponding to objects in the M communication groups. Through interaction among the channel node, the social group node, and the application node, the channel message of the social group channel is synchronized between the communication groups, so that message sending efficiency is improved. When the M communication groups belong to K application programs and K is an integer greater than 1 and less than M, it indicates that at least two communication groups of the M communication groups belong to different application programs. Message synchronization between the social group channel and the communication group is implemented through the social group channel, and message synchronization between communication groups in different application programs is implemented, so that message synchronization is implemented across platforms (different application programs). Besides, interconnection between the plurality of application programs is also implemented through one social group channel, thereby avoiding overheads caused by switching between the plurality of application programs to synchronize a plurality of messages. When the M communication groups all belong to one application program, the plurality of communication groups are interconnected by using the social group channel, to implement message synchronization in the plurality of communication groups and message synchronization between the plurality of communication groups by using the same social group channel, thereby avoiding overheads caused by switching between conversation pages of the plurality of communication groups to synchronize a plurality of messages.

In some embodiments, the channel node may receive the group message synchronization request sent by the social group node. The group message synchronization request carries a group message transmitted in the M communication groups by an object in the social group channel. The group message is synchronized to a terminal corresponding to the object in the social group channel, to implement message synchronization between the communication group and the social group channel, thereby avoiding overheads caused by switching between the group conversation page and the channel conversation page to synchronize a plurality of messages.

Specifically, when the consortium communication protocol specifies that message synchronization is performed in the common message encapsulation format, that is, the message encapsulation format of the group message is the common message encapsulation format, the channel node may directly synchronize the group message in the common message format to the service backend of the main application program corresponding to the social group channel, and the service backend may synchronize the group message to the terminal corresponding to the object in the social group channel. When the consortium communication protocol specifies that message synchronization is performed in a non-common message encapsulation format, that is, the message encapsulation format of the group message is a group message encapsulation format (that is, the non-common message encapsulation format) of the application program corresponding to the communication group, the channel node may convert the message encapsulation format of the group message into the channel message encapsulation format, that is, read the group message, the information of the sender of the group message, the group identifier of the communication group, the program identifier of the application program corresponding to the group message, and the like from the group message in the group message encapsulation format, and encapsulate the group message, the information of the sender of the group message, the group identifier of the communication group, the program identifier of the application program corresponding to the group message, and the like according to the channel message encapsulation format, to obtain the group message in the channel message format. Then, the group message in the channel message encapsulation format may be synchronized to the service backend of the main application program corresponding to the social group channel, and the service backend may synchronize the group message in the channel message encapsulation format to the terminal corresponding to the object in the social group channel. The channel node synchronizes the group message to the social group channel, which helps more users to view the message.

For example, referring to FIG. 11 and FIG. 15, when viewing a message in a channel conversation page, an object of the communication group a (or the communication group b) may request a channel aggregated message of a third-party application program (that is, an application program A and an application program B) through a main application program. As shown in FIG. 15, a specific implementation process includes:

S50: Enter a message page to request message data. For example, an object in the communication group a requests a channel aggregated message in the channel conversation page. The object in the communication group a generates a channel message viewing request in response to a message viewing operation performed on the channel conversation page, and sends the channel message viewing request to the service backend of the main application program. S51: Request a channel aggregated message of an application program (that is, the main application program and a third-party application program). The service backend of the main application program may send the channel message viewing request to the channel node, to request a channel aggregated message in another application program. S52: Invoke a channel smart contract to request a candidate channel aggregated message of the communication group a in the third-party application program. After receiving the channel message viewing request, the channel node may invoke the channel smart contract, and send the channel message viewing request to the social group node, to request the candidate channel aggregated message of the communication group a in the third-party application program. S53: Invoke a social group smart contract to request a group message of the communication group a in the application program A. The social group node may invoke the social group smart contract, and send the channel message viewing request to the application node A to request the group message of the communication group a in the application program A.

S54: Invoke a smart contract B to request a group message of the communication group a in the application program B. The social group node may invoke a social group smart contract, and send the channel message viewing request to the application node B, to request the group message of the communication group a in the application program B. S55: Return the group message of the communication group a in the application program A. The application node A may return the group message of the communication group a in the application program A to the social group node. The group message of the communication group a in the application program A is a message that is sent in a corresponding group conversation page of the communication group a of the application program A by an object in the communication group a and that is not displayed in a channel conversation page of the object in the communication group a. S56: Return the group message of the communication group a in the application program B. The application node B may return the group message of the communication group a in the application program B to the social group node. The group message of the communication group a in the application program B is a message that is sent in a corresponding group conversation page of the communication group a of the application program B by an object in the communication group a and that is not displayed in a channel conversation page of the object in the communication group a.

S57: Aggregate the group messages of the plurality of application programs, and query the relationship chain list to map a relationship chain in another platform in the group message to a relationship chain in the main application program. The social group node may map the relationship chain 3 corresponding to the communication group b to the relationship chain 1 in the main application program, and map the relationship chain 2 corresponding to the communication group a to the relationship chain 1 in the main application program. The group message of the communication group a in the application program A and the group message of the communication group a in the application program B are aggregated (that is, sorted or the like), to obtain the candidate channel aggregated message. S58: Return the candidate channel aggregated message of the communication group a in another application program, and the social group node returns the candidate aggregated message to the channel node. S59: Convert the candidate channel aggregated message of the another platform into a message encapsulation format of the main application program and aggregate the candidate channel aggregated message again with a newly generated message in the current application program. The channel node may convert the message encapsulation format of the candidate channel aggregated message into the channel message encapsulation format in the main application program, to obtain the candidate channel aggregated message in the channel message encapsulation format; and aggregate (for example, sort) the candidate channel aggregated message in the channel message encapsulation format again with the newly generated message in the main application program, to obtain the channel aggregated message of the communication group a. S60: Return the channel aggregated message of the communication group a. The channel node returns the channel aggregated message to the service backend of the main application program. S61: Return the channel aggregated message. The service backend of the main application program returns the channel aggregated message to the terminal corresponding to the object in the communication group a, so that the terminal corresponding to the object in the communication group a may display the channel aggregated message in the channel conversation page.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel sends a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

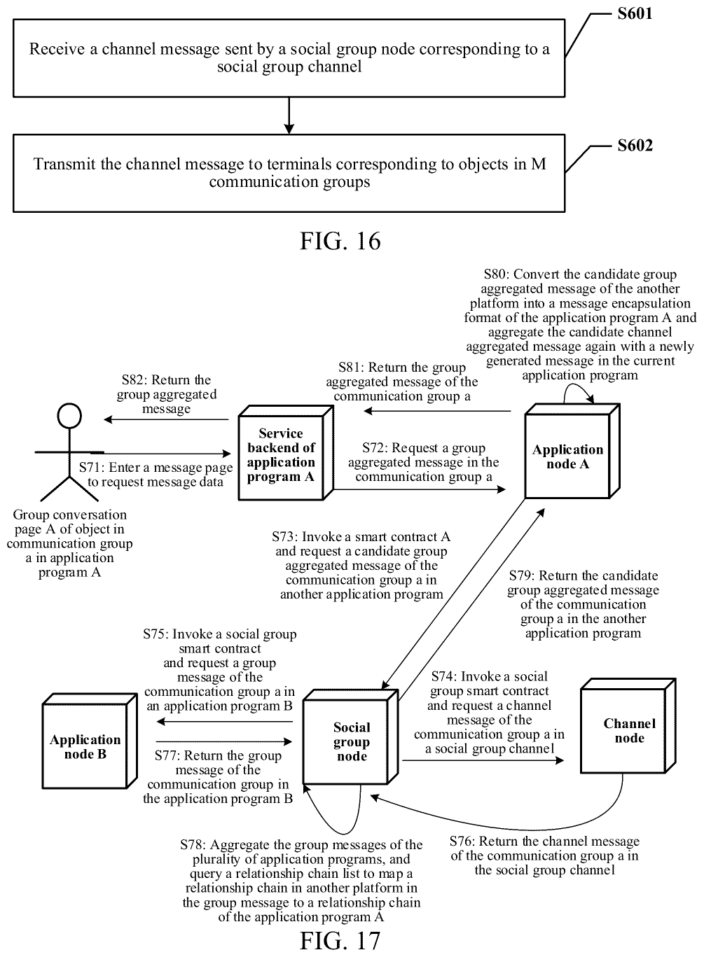

Further, FIG. 16 is a schematic flowchart of a type of message synchronization method according to an embodiment of the present disclosure. As shown in FIG. 16, the method may be performed by any application node corresponding to a communication group of the M communication groups that includes a target object in FIG. 1. The method may include the following operations:

S601: Receive a channel message sent by a social group node corresponding to a social group channel. The channel message is a message transmitted by a target object in the social group channel, and the social group channel is a group organization generated by associating M communication groups; M is an integer greater than or equal to 2, and the target object belongs to at least one communication group of the M communication groups. The channel message is transmitted to the social group node by a channel node corresponding to the social group channel.

In the present disclosure, the application node may receive a channel message sent by the social group node corresponding to the social group channel. The channel message is a message sent by a target object in the social group channel, and the channel message may be sent to the social group node by the channel node corresponding to the social group channel.

S602: Transmit the channel message to terminals corresponding to objects in the M communication groups.

In the present disclosure, the application node may send the channel message to the terminals corresponding to the objects in the M communication groups. For example, the M communication groups include a first communication group, and an application node corresponding to the first communication group is a first application node. In this case, the first application node may send the channel message to a service backend of an application program corresponding to the first communication group, and the service backend may send the channel message to a terminal corresponding to an object in the first communication group.

A message encapsulation format of the channel message is a common message encapsulation format. The first application node does not need to convert the message encapsulation format of the channel message, and may directly synchronize the channel message to the service backend corresponding to the M communication groups. The service backend reads the channel message from the channel message (that is, a message body) in the common message encapsulation format, and sends the channel message to a terminal corresponding to an object in the communication group. When the message encapsulation format of the channel message is a non-common format, that is, the message encapsulation format of the channel message is a channel message encapsulation format, the first application node may convert the message encapsulation format of the channel message into a group message encapsulation format (that is, a message encapsulation format supported by the first application program) corresponding to the first communication group, and synchronize the channel message in the group message encapsulation format to the terminal corresponding to the first communication group.

In some embodiments, the first application node may obtain a group message sent in the first communication group of the M communication groups by a target object, generate a group message synchronization request carrying the group message, and send the group message synchronization request to the social group node; where the social group node is configured to synchronize the group message carried in the group message synchronization request to the channel node corresponding to the social group channel and an application node corresponding to a remaining communication group; and the channel node is configured to synchronize the group message to the social group channel, the application node corresponding to the remaining communication group is configured to synchronize the group message to the remaining communication group, and the remaining communication group is a communication group of the M communication groups other than the first communication group. Through interaction among the application node, the social group node, and the channel node, message synchronization between the communication group and the social group channel and message synchronization between different communication groups may be implemented.

The channel node, a social group node corresponding to the social group channel, and K application nodes are all consortium members satisfying a consortium communication protocol. One of the K application nodes corresponds to one of K application programs. That is, the channel node, the social group node, and the K application nodes may be consortium members in the consortium blockchain network. The consortium communication protocol specifies communication channels, the channel smart contract, and the group smart contract of all the nodes in the consortium blockchain network, and records the relationship chain list of the social group channel and a message synchronization rule. The consortium communication protocol is jointly formulated by the nodes in the consortium blockchain network and is jointly followed. The message synchronization rule may include a message encapsulation format, a message synchronization manner, and the like for message synchronization. The message synchronization manner may be how to synchronize a group message to the social group channel, and how to synchronize a channel message to a communication group. The channel smart contract is recorded in the channel node, and the group smart contract is recorded in the application node. The channel smart contract records a service that the channel node needs to provide, for example, how to synchronize a channel message to a communication group, and records the relationship chain of the social group channel. The group smart contract records a service that an application node needs to provide, for example, how to synchronize a group message to the social group channel, and records a relationship chain in a communication group. The relationship chain list records a list of relationship chains of objects in the social group channel on various application programs. K is an integer greater than 1 and less than or equal to M.

The consortium communication protocol may specify that message synchronization is performed in a common message encapsulation format. The common message encapsulation format may be a message encapsulation format uniformly used for message synchronization of the communication groups in the social group channel and the social group channel, that is, the common message encapsulation format may be a message encapsulation format supported by (compatible with) both each third-party application program and the main application program. The message encapsulation format supported by both each third-party application program and the main application program may mean that each third-party application program and the main application program both have a capability of decapsulating a message in the common message encapsulation format or encapsulating a message into the common message encapsulation format. The common message encapsulation format is recorded in the consortium communication protocol. The common message encapsulation format may be a message encapsulation format used by the main application program and the third-party application program to send messages. The message encapsulation format defines a message header and a message body. The message header includes a plurality of fields, for example, a sender field for writing information about a sender, and the message body is used for writing content of a message (for example, a channel message or a group message). Message headers corresponding to different message encapsulation formats can carry different amounts of data, and/or quantities of fields in message headers are different.

For example, when the consortium communication protocol specifies that message synchronization is performed in the common message encapsulation format, the first application node may obtain the common message encapsulation format from the consortium communication protocol. The first application node may encapsulate, according to the common message encapsulation format, the group message, a group identifier (for example, a serial number and a name) of the first communication group, a program identifier of the first application program, information of the sender of the group message, and the like, to obtain the group message in the common message encapsulation format. The group message in the common message encapsulation format is determined as the group message synchronization request carrying the group message. When the consortium communication protocol specifies that message synchronization is performed in a non-common message encapsulation format, the first application node may obtain, from the consortium communication protocol, a group message encapsulation format corresponding to an application program to which the first communication group belongs, and may encapsulate, according to the group message encapsulation format, the group message, a group identifier (for example, a serial number and a name) of the first communication group, a program identifier of the first application program, information of the sender of the group message, and the like, to obtain the group message in the group message encapsulation format. The group message in the group message encapsulation format is determined as the group message synchronization request carrying the group message.

For example, referring to FIG. 11 and FIG. 17, when viewing a message in the group conversation page corresponding to the communication group a, an object in the communication group a may request the group aggregated message in the application program B and the main application program through the application program A. Similarly, when viewing a message in the group conversation page corresponding to the communication group b, an object in the communication group b may request the group aggregated message in the application program A and the main application program through the application program B. As shown in FIG. 17, a specific implementation process includes: S71: Enter a message page to request message data. For example, an object in the communication group a requests a group aggregated message in the group conversation page of the communication group a. The object in the communication group a generates a group message viewing request in response to a message viewing operation performed on the group conversation page of the communication group a, and sends the group message viewing request to the service backend of the application program A. S72: Request a group aggregated message in the communication group a. The service background of the application program A may send the group message viewing request to the application node A to request a group aggregated message in another application program. S73: Invoke a smart contract A to request a candidate group aggregated message of the communication group a in another application program. After receiving the group message viewing request, the application node A may invoke the smart contract A, and send the group message viewing request to the social group node, to request the candidate group aggregated message of the communication group a in the application program B and the main application program. S74: Invoke a social group smart contract to request a channel message of the communication group a in the social group channel. The social group node may invoke the social group smart contract, and send the group message viewing request to the channel node to request the channel message of the communication group a in the social group channel. S75: Invoke a social group smart contract to request a group message of the communication group a in the application program B. The social group node may invoke a social group smart contract, and send the group message viewing request to the application node B, to request the group message of the communication group a in the application program B.

S76: Return the channel message of the communication group a in the social group channel. The channel node may return the channel message of the communication group a in the main application program to the social group node. The channel message of the communication group a in the main application program is a message that is sent in the channel conversation page by an object in the social group channel and that is not displayed in a group conversation page of the object in the communication group a. S77: Return the group message of the communication group in the application program B. The application node B may return the group message of the communication group a in the application program B to the social group node. The group message of the communication group a in the application program B is a message that is sent in a corresponding group conversation page of the communication group a of the application program B by an object in the communication group a and that is not displayed in a group conversation page of the object in the communication group a. S78: Aggregate the group messages of the plurality of application programs, and query the relationship chain list to map a relationship chain in another platform in the group message to a relationship chain of the application program A. The social group node may map the relationship chain 3 corresponding to the communication group b to the relationship chain 4 in the application program A, and map the relationship chain 1 corresponding to the social group channel to the relationship chain 2 in the application program A. The group message of the communication group a in the application program B and the channel message of the communication group a in the social group channel are aggregated (that is, sorted or the like), to obtain the candidate group aggregated message. S79: Return the candidate group aggregated message of the communication group a in another application program. The social group node returns the candidate group aggregated message to the application node A. S80: Convert the candidate group aggregated message of the another platform into a message encapsulation format of the application program A and aggregate the candidate channel aggregated message again with a newly generated message in the current application program. The application node A may convert the message encapsulation format of the candidate group aggregated message into a group message encapsulation format in the application program A, to obtain the candidate group aggregated message in the group message encapsulation format; and aggregate (for example, sort) the candidate group aggregated message in the group message encapsulation format again with the newly generated group message in the application program A, to obtain the group aggregated message of the communication group a. S81: Return the group aggregated message of the communication group a. The application node A returns the group aggregated message to the service background of the application program A. S82: Return the group aggregated message. The service backend of the application program A returns the group aggregated message to the terminals corresponding to the objects in the communication group a, so that the terminals corresponding to the objects in the communication group a may display the group aggregated message in the group conversation page of the communication group a.

After the social group node, the application nodes, and the channel node receive a to-be-synchronized message (at least one of a channel message and a group message), the target node may query a blockchain for a digital member authorization proof of a sender of the to-be-synchronized message according to information of the sender. If the digital member authorization proof of the sender is not found, it indicates that the sender does not allow the to-be-synchronized message to be synchronized between the social group channel and the M communication groups, and the target node may suspend synchronizing the to-be-synchronized message to the social group channel and the M communication groups. If the digital member authorization proof of the sender is found, it indicates that the sender allows the to-be-synchronized message to be synchronized between the social group channel and the M communication groups, and the target node may synchronize the to-be-synchronized message to the social group channel and the M communication groups. The target node herein may be at least one of the social group node, the application nodes, and the channel node. For example, the target node may be a node that first receives the to-be-synchronized message. When the to-be-synchronized message is a channel message, the target node may be the channel node. When the to-be-synchronized message is a group message, the target node may be an application node corresponding to a communication group to which the group message belongs. In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel sends a channel message in the social group channel, an object in the social group channel can view the channel message in the channel conversation page corresponding to the social group channel. In addition, the channel message is also synchronized to a communication group associated with the social group channel, to implement message synchronization between the social group channel and the plurality of communication groups. In a message sending process, there is no need to switch between the channel conversation page and a group conversation page of the communication group, thereby simplifying a message sending process and improving message sending efficiency.

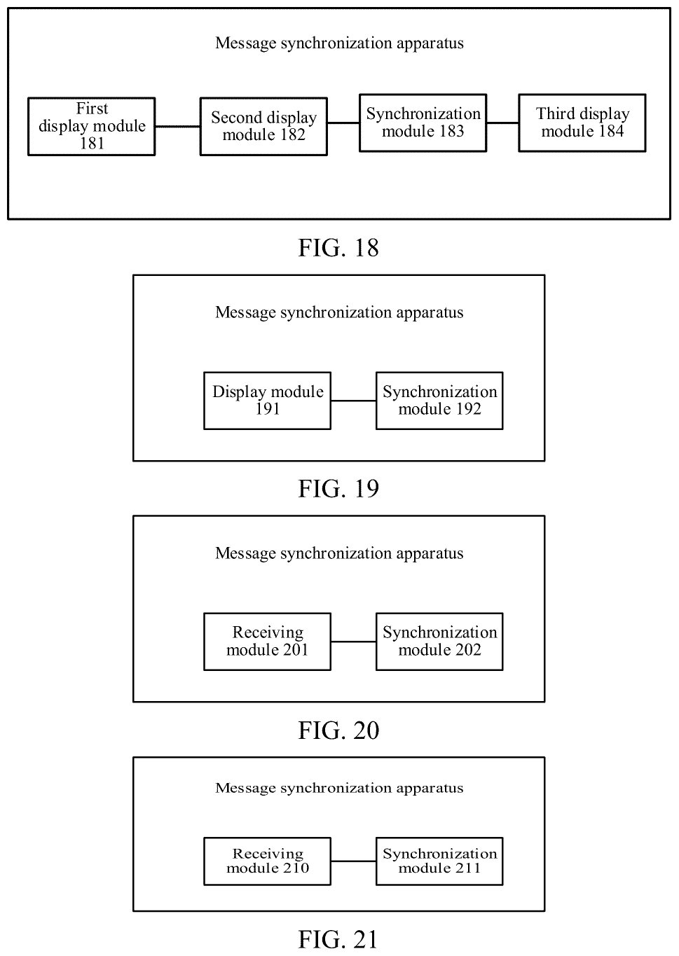

FIG. 18 is a schematic structural diagram of a type of message synchronization apparatus according to an embodiment of the present disclosure. As shown in FIG. 18, the message synchronization apparatus may include:
a first display module 181, configured to display a channel conversation page corresponding to a social group channel; the social group channel being a group organization generated by associating M communication groups; and M being an integer greater than or equal to 2; and
a second display module 182, configured to display a channel message in the channel conversation page in response to a channel message transmission operation triggered in the social group channel; the channel message being obtained according to the channel message transmission operation; and
a synchronization module 183, configured to synchronize the channel message to the M communication groups.

In some embodiments, the displaying, by the second display module 182 in the channel conversation page in response to a channel message transmission operation triggered in the social group channel, a channel message obtained through the channel message transmission operation includes:
displaying a channel aggregated message in the channel conversation page in response to the channel message transmission operation triggered in the social group channel, where the channel aggregated message includes the channel message; the channel aggregated message is obtained by aggregating the channel message and a to-be-displayed channel message that is to be displayed in the social group channel, and the to-be-displayed channel message is a group message transmitted in the M communication groups by an object in the social group channel.

In some embodiments, the M communication groups belong to K application programs, and K is an integer greater than 1 and less than or equal to M.

The apparatus further includes: a third display module 184, configured to display the channel message and source information of the channel message in a group conversation page of a first communication group of the M communication groups in response to a message viewing operation performed on the first communication group; where the source information of the channel message indicates that the channel message comes from the social group channel.

In some embodiments, the displaying, by the third display module 184, the channel message in a group conversation page of a first communication group includes:
displaying a group aggregated message in the group conversation page of the first communication group; where the group aggregated message includes the channel message; and the group aggregated message is obtained by aggregating the channel message and a to-be-displayed group message that is to be displayed in the first communication group, and the to-be-displayed group message is a group message transmitted in the M communication groups by an object in the social group channel.

In some embodiments, the third display module 184 is further configured to display a candidate application list in response to a group addition request of a target object for the social group channel; where the candidate application list includes at least one candidate application program; and the target object is an object that initiates the channel message transmission operation, and the target object belongs to at least one communication group of the M communication groups; display, in response to a selection operation performed on a second application program in the candidate application list, a communication group associated with the target object in the second application program; and add an object in the second communication group to the social group channel in response to a selection operation performed on a second communication group associated with the target object in the second application program.

In some embodiments, the adding, by the third display module 184, an object in the second communication group to the social group channel in response to a selection operation performed on a second communication group associated with the target object in the second application program includes:
generating an addition authorization request in response to the selection operation on the second communication group associated with the target object in the second application program; where the addition authorization request is configured for adding an object in the second communication group to the social group channel;
transmitting the addition authorization request to the object in the second communication group; and
adding the object in the second communication group to the social group channel in response to that an authorization permission message transmitted by the object in the second communication group is received.

In some embodiments, the addition authorization request includes authorization prompt information, the authorization prompt information is displayed in the group conversation page of the second communication group, the authorization prompt information includes channel description information of the social group channel and message synchronization prompt information, and the message synchronization prompt information is configured for prompting that after the object in the second communication group is added to the social group channel, a group message and a channel message transmitted by the object in the second communication group are allowed to be synchronized in the social group channel and the communication group in the social group channel.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel sends a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

FIG. 19 is a schematic structural diagram of a type of message synchronization apparatus according to an embodiment of the present disclosure. As shown in FIG. 19, the message synchronization apparatus may include:
a display module 191, configured to display a group message in a group conversation page of a first communication group in response to a group message transmission operation triggered in the first communication group; the group message being obtained according to the group message transmission operation; the first communication group being one of M communication groups corresponding to a social group channel, the social group channel being a group organization generated by associating the M communication groups, and M being an integer greater than or equal to 2; and
a synchronization module 192, configured to synchronize the group message to the social group channel and a remaining communication group of the M communication groups other than the first communication group.

In some embodiments, the M communication groups belong to K application programs, and K is an integer greater than 2 and less than or equal to M.

In some embodiments, the display module 191 is further configured to display, in a channel conversation page of the social group channel in response to a message viewing operation performed on the social group channel, a channel aggregated message including the group message, where the channel aggregated message is obtained by aggregating the group message and a to-be-displayed channel message that is to be displayed in the social group channel, and the to-be-displayed channel message is at least one of a channel message sent in the social group channel and a group message sent in the remaining communication group.

In some embodiments, the display module 191 is further configured to display the group message and source information of the group message in a channel conversation page of the social group channel in response to a message viewing operation performed on the social group channel; where the source information of the group message indicates that the group message comes from the first communication group.

In some embodiments, the displaying, by the display module 191, the group message in a channel conversation page of the social group channel in response to a message viewing operation performed on the social group channel includes:
displaying prompt information in a session home page of a channel application program of the social group channel; where the prompt information is configured for prompting that there is a to-be-viewed message in the social group channel;
updating the session home page to the channel conversation page of the social group channel in response to a trigger operation performed on the prompt information; and
displaying the group message in the channel conversation page of the social group channel.

In some embodiments, the displaying, by the display module 191, in a group conversation page of a first communication group in response to a group message transmission operation triggered in the first communication group, a group message obtained through the group message transmission operation includes:
displaying, in a corresponding group conversation page of a first communication group in response to a group message transmission operation triggered in the first communication group, a group aggregated message including the group message; where the group aggregated message is obtained by aggregating the group message and a to-be-displayed group message that is to be displayed in the first communication group, and the to-be-displayed group message is at least one of a channel message sent in the social group channel by an object in the social group channel and a group message sent in the remaining communication group.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When an object in the social group sends a group message in the M communication groups, the group message is synchronized to the social group channel and another communication group, to implement message synchronization between the communication group and the social group channel, and also implement message synchronization between different communication groups. In a message sending process, there is no need to switch between the channel conversation page and a group conversation page of the communication group, thereby simplifying a message sending process and improving message sending efficiency.

FIG. 20 is a schematic structural diagram of a type of message synchronization apparatus according to an embodiment of the present disclosure. As shown in FIG. 20, the message synchronization apparatus may include:
a receiving module 201, configured to receive a channel message synchronization request sent by a channel node corresponding to a social group channel; the channel message synchronization request carrying a channel message; the channel message being transmitted in the social group channel by an object in the social group channel; the social group channel being a group organization generated by associating the M communication groups; and M being an integer greater than or equal to 2; and
a synchronization module 202, configured to synchronize the channel message to application nodes corresponding to the M communication groups; the application nodes corresponding to the M communication groups being configured to synchronize the channel message to the M communication groups.

The channel node, a social group node that receives the channel message synchronization request, and K application nodes are all consortium members satisfying a consortium communication protocol. One of the K application nodes to which the M communication groups belong corresponds to one of K application programs, and the M communication groups include a first communication group. K is an integer greater than 1 and less than M. The M communication groups include the first communication group.

In some embodiments, the synchronizing, by the synchronization module 202, the channel message to application nodes corresponding to the M communication groups includes:
obtaining, from the consortium communication protocol, a relationship chain list and a first relationship chain that corresponds to the social group channel; where the first relationship chain includes a mapping relationship between an object channel identifier that is of an object in the social group channel and that is in the social group channel and a digital identifier of the object in the social group channel; and
mapping, according to the relationship chain list, the first relationship chain to a second relationship chain corresponding to the first communication group; where the second relationship chain includes a mapping relationship between an object group identifier that is of an object in the first communication group and that is in the first communication group and a digital identifier of the object in the first communication group; and the social group channel includes the object in the first communication group; and
sending the second relationship chain and the channel message to a first application node corresponding to an application program to which the first communication group belongs; where the first application node is configured to synchronize the channel messages to the first communication group according to the second relationship chain.

In some embodiments, the sending, by the synchronization module 202, the second relationship chain and the channel message to a first application node corresponding to an application program to which the first communication group belongs includes:
obtaining a to-be-displayed group message from an application node corresponding to a remaining communication group; where the to-be-displayed group message is a message that is sent in the remaining communication group by an object in the social group channel and that is to be displayed in the first communication group; and the remaining communication group is a communication group of the M communication groups other than the first communication group;
aggregating the channel message and the to-be-displayed group message to obtain a candidate group aggregated message; and
sending the candidate group aggregated message and the second relationship chain to the first application node corresponding to the application program to which the first communication group belongs; where the first application node is configured to synchronize a group aggregated message to the first communication group; and the group aggregated message is obtained by aggregating the candidate group aggregated message and the to-be-displayed group message that is transmitted in the first communication group by the object in the first communication group.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel sends a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

FIG. 21 is a schematic structural diagram of a type of message synchronization apparatus according to an embodiment of the present disclosure. As shown in FIG. 21, the message synchronization apparatus may include:
a receiving module 210, configured to receive a group message synchronization request from a first application node corresponding to a first communication group; the group message synchronization request carrying a group message transmitted by a target object in the first communication group, the first communication group being one of M communication groups corresponding to a social group channel, the social group channel being a group organization generated after associating the M communication groups, the target object being an object in the first communication group, and M being an integer greater than or equal to 2; and
a synchronization module 211, configured to synchronize the group message to a channel node corresponding to the social group channel and an application node corresponding to a remaining communication group of the M communication groups other than the first communication group; the channel node being configured to synchronize the group message to the social group channel; and the application node corresponding to the remaining communication group being configured to synchronize the group message to the remaining communication group.

In some embodiments, the channel node, a social group node that receives the group message synchronization request, and K application nodes are all consortium members satisfying a consortium communication protocol. One of the K application nodes to which the M communication groups belong corresponds to one of K application programs, and K is a positive integer greater than 1 and less than or equal to M.

The synchronizing, by the synchronization module 211, the group message to a channel node corresponding to the social group channel includes:
obtaining, from the consortium communication protocol, a relationship chain list and a second relationship chain that corresponds to the first communication group; where the second relationship chain includes a mapping relationship between an object group identifier that is of an object in the first communication group and that is in the first communication group and a digital identifier of the object in the first communication group;
mapping, according to the relationship chain list, the second relationship chain to a first relationship chain corresponding to the social group channel; where the first relationship chain includes a mapping relationship between an object channel identifier that is of an object in the social group channel and that is in the social group channel and a digital identifier of the object in the social group channel; and the social group channel includes the object in the first communication group; and
transmitting the first relationship chain and the group message to the channel node corresponding to the social group channel; where the channel node is configured to synchronize the group message to the social group channel according to the first relationship chain.

In some embodiments, the transmitting, by the synchronization module 211, the first relationship chain and the group message to the channel node corresponding to the social group channel includes:
obtaining a to-be-displayed channel message from the application node corresponding to the remaining communication group; where the to-be-displayed channel message is a message that is transmitted in the remaining communication group by an object in the social group channel and that is to be displayed in the social group channel;
aggregating the to-be-displayed channel message corresponding to the remaining communication group and the group message, to obtain a candidate channel aggregated message; and
transmitting the candidate channel aggregated message and the first relationship chain to the channel node corresponding to the social group channel; where the channel node is configured to synchronize the channel aggregated message to the social group channel; and the channel aggregated message is obtained by aggregating the candidate channel aggregated message and the to-be-displayed channel message transmitted in the social group channel by the object in the social group channel.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel sends a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

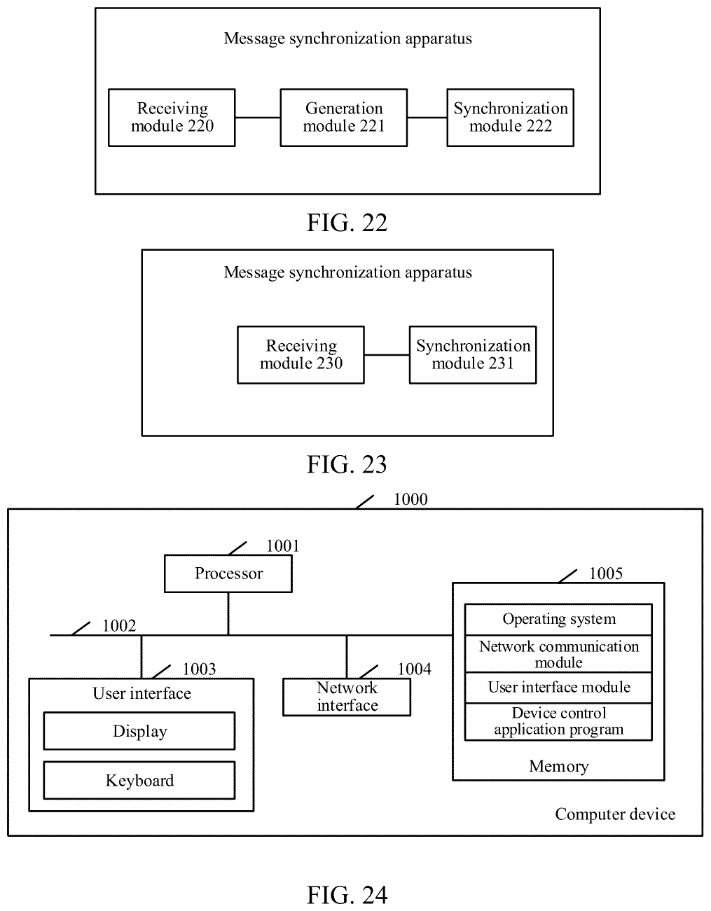

FIG. 22 is a schematic structural diagram of a type of message synchronization apparatus according to an embodiment of the present disclosure. As shown in FIG. 22, the message synchronization apparatus may include:
a receiving module 220, configured to receive a channel message from a terminal corresponding to a target object in a social group channel; the channel message being transmitted by the target object in the social group channel; the social group channel being a group organization generated by associating the M communication groups; and M being an integer greater than or equal to 2, and the target object belonging to at least one communication group of the M communication groups; and
a generation module 221, configured to generate a channel message synchronization request; the channel message synchronization request carrying the channel message; and
a synchronization module 222, configured to transmit the channel message synchronization request to a social group node; the social group node being configured to synchronize, according to the channel message synchronization request, the channel message to application nodes corresponding to the M communication groups, and the application nodes corresponding to the M communication groups being configured to synchronize the channel message to terminals corresponding to objects in the M communication groups.

In some embodiments, the social group node, a channel node corresponding to the social group channel, and K application nodes are all consortium members satisfying a consortium communication protocol. One of the K application nodes to which the M communication groups belong corresponds to one of K application programs, and K is an integer greater than 1 and less than or equal to M.

The generating, by the synchronization module 222, a channel message synchronization request carrying the channel message includes:
obtaining a common message encapsulation format from the consortium communication protocol; and encapsulating the channel message according to the common message encapsulation format, to obtain the channel message synchronization request; or
obtaining a channel message encapsulation format corresponding to the social group channel from the consortium communication protocol; and encapsulating the channel message according to the channel message encapsulation format, to obtain the channel message synchronization request.

In some embodiments, the receiving module 220 is further configured to receive a group message synchronization request from the social group node; where the group message synchronization request carries a group message transmitted in the M communication groups by an object in the social group channel.

In some embodiments, the synchronization module 222 is further configured to synchronize the group message to a terminal corresponding to an object in the social group channel.

In some embodiments, the synchronizing, by the synchronization module 222, the group message to a terminal corresponding to the object in the social group channel includes:
in response to that a message encapsulation format of the group message is the common message encapsulation format, synchronizing the group message in the common message encapsulation format to the terminal corresponding to the object in the social group channel; or
in response to that a message encapsulation format of the group message is a non-common message encapsulation format, converting the message encapsulation format of the group message to a channel message encapsulation format, to obtain the group message in the channel message encapsulation format; and synchronizing the group message in the channel message encapsulation format to the terminal corresponding to the object in the social group channel.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel sends a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

FIG. 23 is a schematic structural diagram of a type of message synchronization apparatus according to an embodiment of the present disclosure. As shown in FIG. 23, the message synchronization apparatus may include:
a receiving module 230, configured to receive a channel message from a social group node corresponding to a social group channel; the channel message being a message transmitted by a target object in the social group channel, and the social group channel being a group organization generated by associating M communication groups; M being an integer greater than or equal to 2, and the target object belonging to at least one communication group of the M communication groups; and the channel message being transmitted to the social group node by a channel node corresponding to the social group channel; and
a synchronization module 231, configured to transmit the channel message to terminals corresponding to objects in the M communication groups.

The synchronization module 231 is configured to obtain a group message transmitted in a first communication group of the M communication groups by the target object;
generate a group message synchronization request; where the group message synchronization request carries the group message; and
transmit the group message synchronization request to the social group node; where the social group node is configured to synchronize the group message to the channel node corresponding to the social group channel and an application node corresponding to a remaining communication group; and the channel node is configured to synchronize the group message to the social group channel, the application node corresponding to the remaining communication group is configured to synchronize the group message to the remaining communication group, and the remaining communication group is a communication group of the M communication groups other than the first communication group.

In some embodiments, the social group node, the channel node, and K application nodes are all consortium members satisfying a consortium communication protocol. One of the K application nodes to which the M communication groups belong corresponds to one of K application programs, and K is a positive integer less than M.

The generating, by the synchronization module 231, a group message synchronization request includes:
obtaining a common message encapsulation format from the consortium communication protocol; and encapsulating the group message according to the common message encapsulation format, to obtain the group message synchronization request; or
obtaining, from the consortium communication protocol, a group message encapsulation format corresponding to an application program to which the first communication group belongs; and encapsulating the group message according to the group message encapsulation format, to obtain the group message synchronization request.

In the present disclosure, the plurality of communication groups are associated to obtain the social group channel, that is, different communication groups are aggregated to obtain a super social group (that is, the social group channel). The social group channel includes objects in the plurality of communication groups, interconnection with the plurality of communication groups is implemented through the social group channel, and unified management of the plurality of communication groups is implemented through the social group channel, so that convenience of message interaction is improved. When any object in the social group channel transmits a channel message in the social group channel, an object in the social group channel can view the channel message in the channel conversation page corresponding to the social group channel. In addition, the channel message is also synchronized to a communication group associated with the social group channel, to implement message synchronization between the social group channel and the communication group. In a message sending process, there is no need to switch between the channel conversation page and a group conversation page of the communication group, thereby simplifying a message sending process and improving message sending efficiency.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

FIG. 24 is a schematic structural diagram of a computer device according to an embodiment of the present disclosure. As shown in FIG. 24, a computer device 1000 may be the node in the foregoing method, and may be specifically a terminal or a server. The computer device includes: a processor 1001, a network interface 1004, and a memory 1005, and in addition, the computer device 1000 may further include: a user interface 1003 and at least one communication bus 1002. The communication bus 1002 is configured to implement connection and communication between these components. In some embodiments, the user interface 1003 may include a display, a keyboard, and in some embodiments, the user interface 1003 may further include a standard wired interface and a standard wireless interface. In some embodiments, the network interface 1004 may include a standard wired interface and wireless interface (for example, a WiFi interface). The memory 1005 may be a high-speed RAM memory, or may be a non-volatile memory, for example, at least one magnetic disk memory. In some embodiments, the memory 1005 may be at least one storage apparatus that is located far away from the processor 1001. As shown in FIG. 24, the memory 1005 used as a computer-readable storage medium may include an operating system, a network communication module, a user interface module, and a computer application program.

In the computer device 1000 shown in FIG. 24, the network interface 1004 may provide a network communication function. The user interface 1003 is mainly configured to provide an input interface. The processor 1001 may be configured to invoke a computer application program stored in the memory 1005.

The computer device described in this embodiment of the present disclosure can implement the descriptions of the message synchronization method in the foregoing corresponding embodiments, and can also implement the descriptions of the message synchronization apparatus in the foregoing corresponding embodiments. Details are not described herein again. In addition, the description of beneficial effects of the same method are not described herein again.

In addition, an embodiment of the present disclosure further provides a computer-readable storage medium. The computer-readable storage medium stores a computer program executed by the foregoing message synchronization apparatus. The computer program includes program instructions. When executing the program instructions, the processor can perform the descriptions of the message synchronization method in the foregoing corresponding embodiments. Therefore, details are not repeated herein. In addition, the description of beneficial effects of the same method are not described herein again. For technical details that are not disclosed in the computer-readable storage medium embodiments of the present disclosure, refer to the descriptions of the method embodiments of the present disclosure.

As an example, the program instructions may be deployed for execution on one computer device, or deployed for execution on at least two computer devices located at one location, or distributed on at least two computer devices distributed in at least two locations and interconnected through a communication network. The at least two computer devices distributed at the at least two locations and interconnected through a communication network can form a blockchain network.

The computer-readable storage medium may be the message synchronization apparatus provided in any one of the foregoing embodiments or an internal storage unit of the foregoing computer device, such as a hard disk or a memory of the computer device. The computer-readable storage medium may also be an external storage device of the computer device, such as a plug-in hard disk equipped on the computer device, a smart media card (SMC), a secure digital (SD) card, a flash card, or the like. Further, the computer-readable storage medium may also include both the internal storage unit and the external storage device of the computer device. The computer-readable storage medium is configured to store the computer program and other programs and data required by the computer device. The computer-readable storage medium can also be configured to temporarily store data that has been outputted or will be outputted.

The terms “first” and “second” in the specification, claims, and accompanying drawings of the embodiments of the present disclosure are used for distinguishing between different media content, and are not used for describing a specific sequence. In addition, the term “include” and any variant thereof are intended to cover a non-exclusive inclusion. For example, a process, a method, an apparatus, a product, or a device that includes a series of operations or units is not limited to the listed operations or modules; and instead, in some embodiments, further includes an operation or a module that is not listed, or in some embodiments, further includes another operation or unit that is intrinsic to the process, method, apparatus, product, or device.

In the embodiments of the present disclosure, if user information needs to be used, it is necessary to obtain user permission or consent and comply with relevant laws and regulations of relevant countries and regions.

An embodiment of the present disclosure further provides a computer program product, including a computer program/instruction. When the computer program/instruction is executed by a processor, the descriptions of the message synchronization method in the foregoing corresponding embodiments are performed. Therefore, details are not repeated herein. In addition, the description of beneficial effects of the same method are not described herein again. For technical details not disclosed in the computer program product in the embodiments of the present disclosure, refer to the description in the method embodiment of the present disclosure.

A person of ordinary skill in the art may be aware that, in combination with the examples described in the embodiments disclosed in this specification, units and algorithm operations may be implemented by electronic hardware, computer software, or a combination thereof. To clearly describe the interchangeability between the hardware and the software, the foregoing has generally described compositions and operations of each example according to functions. Whether the functions are executed by hardware or software depends on particular applications and design constraint conditions of the technical solutions. A person skilled in the art can use different methods to implement the described functions for each particular application, but it is not considered that the implementation goes beyond the scope of the present disclosure.

The method and the related apparatus provided in the embodiments of the present disclosure are described with reference to the method flowchart and/or the schematic structural diagram provided in the embodiments of the present disclosure. Specifically, each procedure and/or block in the method flowchart and/or the schematic structural diagram and a combination of the procedure and/or block in the flowchart and/or the block diagram may be implemented by using computer program instructions. These computer program instructions may be provided to a general-purpose computer, a dedicated computer, an embedded processor, or a processor of another programmable network connection device to generate a machine, so that the instructions executed by the computer or the processor of the another programmable network connection device generate an apparatus for implementing a specific function in one or more procedures in the flowcharts and/or in one or more blocks in the schematic structural diagrams. These computer program instructions may also be stored in a computer-readable memory that can instruct the computer or another programmable network connection device to work in a specific manner, so that the instructions stored in the computer-readable memory generate an artifact that includes an instruction apparatus. The instruction apparatus implements a specific function in one or more procedures in the flowcharts and/or in one or more blocks in the schematic structural diagram. These computer program instructions may also be loaded onto a computer or another programmable network connection device, so that a series of operations are performed on the computer or the another programmable device, thereby generating computer-implemented processing. Therefore, the instructions executed on the computer or the another programmable device provide operations for implementing a specific function in one or more procedures in the flowcharts and/or in one or more blocks in the schematic structural diagram.

What is disclosed above is merely exemplary embodiments of the present disclosure, and certainly is not intended to limit the scope of the claims of the present disclosure. Therefore, equivalent variations made in accordance with the claims of the present disclosure shall fall within the scope of the present disclosure.

What is claimed is:

1. A message synchronization method, performed by a terminal, comprising:
displaying a channel conversation page corresponding to a social group channel; the social group channel being a group organization generated by associating M communication groups; and M being an integer greater than or equal to 2;
obtaining a channel message according to a channel message transmission operation triggered in the social group channel;
displaying the channel message in the channel conversation page in response to the channel message transmission operation; and
synchronizing the channel message to the M communication groups.

2. The method according to claim 1, wherein the displaying a channel message in the channel conversation page in response to a channel message transmission operation triggered in the social group channel comprises:
obtaining a first group message transmitted in the M communication groups by an object in the social group channel, the first group message is to be displayed in the social group channel;
aggregating the channel message and the first group message to obtain a first channel aggregated message; and
displaying the first channel aggregated message in the channel conversation page in response to the channel message transmission operation triggered in the social group channel.

3. The method according to claim 1, wherein the M communication groups belong to K application programs, and K is an integer greater than 1 and less than or equal to M.

4. The method according to claim 1, further comprising:
displaying the channel message and source information of the channel message in a group conversation page of a first communication group of the M communication groups in response to a message viewing operation performed on the first communication group; wherein the source information of the channel message indicates that the channel message comes from the social group channel.

5. The method according to claim 4, wherein the displaying the channel message in a group conversation page of a first communication group comprises:
obtaining a second group message transmitted in the M communication groups by an object in the social group channel, the second group message is to be displayed in the first communication group;
aggregating the channel message and the second group message to obtain a second channel aggregated message; and
displaying the second group aggregated message in the group conversation page of the first communication group.

6. The method according to claim 1, further comprising:
displaying a candidate application list in response to a group addition request of a target object for the social group channel; wherein the candidate application list comprises at least one candidate application program; and the target object is an object that initiates the channel message transmission operation, and the target object belongs to at least one communication group of the M communication groups;
displaying, in response to a selection operation performed on a second application program in the candidate application list, the second communication group associated with the target object in the second application program; and
adding an object in the second communication group to the social group channel in response to a selection operation performed on a second communication group associated with the target object in the second application program.

7. The method according to claim 6, wherein the adding an object in the second communication group to the social group channel in response to a selection operation performed on a second communication group associated with the target object in the second application program comprises:
generating an addition authorization request in response to the selection operation on the second communication group associated with the target object in the second application program; wherein the addition authorization request is configured for adding an object in the second communication group to the social group channel;
transmitting the addition authorization request to the object in the second communication group; and
adding the object in the second communication group to the social group channel in response to that an authorization permission message transmitted by the object in the second communication group is received.

8. The method according to claim 7, wherein the addition authorization request comprises authorization prompt information, the authorization prompt information is displayed in the group conversation page of the second communication group, the authorization prompt information comprises channel description information of the social group channel and message synchronization prompt information, and the message synchronization prompt information is configured for prompting that after the object in the second communication group is added to the social group channel, a group message and a channel message transmitted by the object in the second communication group are allowed to be synchronized in the social group channel and the communication group in the social group channel.

9. A message synchronization method, performed by a channel node, comprising:
receiving a channel message from a terminal corresponding to a target object in a social group channel; the channel message being transmitted by the target object in the social group channel; the social group channel being a group organization generated by associating the M communication groups; and M being an integer greater than or equal to 2, and the target object belonging to at least one communication group of the M communication groups;
generating a channel message synchronization request; the channel message synchronization request carrying the channel message; and
transmitting the channel message synchronization request to a social group node; the social group node being configured to synchronize, according to the channel message synchronization request, the channel message to application nodes corresponding to the M communication groups, and the application nodes corresponding to the M communication groups being configured to synchronize the channel message to terminals corresponding to objects in the M communication groups.

10. The method according to claim 9, wherein the social group node, the channel node corresponding to the social group channel, and K application nodes are consortium members satisfying a consortium communication protocol; and one of the K application nodes to which the M communication groups belong corresponds to one of K application programs, and K is an integer greater than 1 and less than or equal to M; and
the generating a channel message synchronization request comprises:
obtaining a common message encapsulation format from the consortium communication protocol; and encapsulating the channel message according to the common message encapsulation format, to obtain the channel message synchronization request; or
obtaining a channel message encapsulation format corresponding to the social group channel from the consortium communication protocol; and encapsulating the channel message according to the channel message encapsulation format, to obtain the channel message synchronization request.

11. The method according to claim 9, further comprising:
receiving a group message synchronization request from the social group node; wherein the group message synchronization request carries a group message transmitted in the M communication groups by an object in the social group channel; and
synchronizing the group message to a terminal corresponding to the object in the social group channel.

12. The method according to claim 11, wherein the synchronizing the group message to a terminal corresponding to the object in the social group channel comprises:
in response to that a message encapsulation format of the group message is the common message encapsulation format, synchronizing the group message in the common message encapsulation format to the terminal corresponding to the object in the social group channel.

13. The method according to claim 11, wherein the synchronizing the group message to a terminal corresponding to the object in the social group channel comprises:
in response to that a message encapsulation format of the group message is a non-common message encapsulation format, converting the message encapsulation format of the group message to a channel message encapsulation format, to obtain the group message in the channel message encapsulation format; and synchronizing the group message in the channel message encapsulation format to the terminal corresponding to the object in the social group channel.

14. A non-transitory computer-readable storage medium, having a computer program stored therein, and when a processor executes the computer program, the computer program causing the processor to implement:
displaying a channel conversation page corresponding to a social group channel; the social group channel being a group organization generated by associating M communication groups; and M being an integer greater than or equal to 2;
obtaining a channel message according to a channel message transmission operation triggered in the social group channel;
displaying the channel message in the channel conversation page in response to the channel message transmission operation; and
synchronizing the channel message to the M communication groups.

15. The storage medium according to claim 14, wherein the displaying a channel message in the channel conversation page in response to a channel message transmission operation triggered in the social group channel comprises:
obtaining a first group message transmitted in the M communication groups by an object in the social group channel, the first group message is to be displayed in the social group channel;
aggregating the channel message and the first group message to obtain a first channel aggregated message; and
displaying the first channel aggregated message in the channel conversation page in response to the channel message transmission operation triggered in the social group channel.

16. The storage medium according to claim 14, wherein the M communication groups belong to K application programs, and K is an integer greater than 1 and less than or equal to M.

17. The storage medium according to claim 14, wherein the computer program further causes the processor to implement:
displaying the channel message and source information of the channel message in a group conversation page of a first communication group of the M communication groups in response to a message viewing operation performed on the first communication group; wherein the source information of the channel message indicates that the channel message comes from the social group channel.

18. The storage medium according to claim 17, wherein the displaying the channel message in a group conversation page of a first communication group comprises:
obtaining a second group message transmitted in the M communication groups by an object in the social group channel, the second group message is to be displayed in the first communication group;
aggregating the channel message and the second group message to obtain a second channel aggregated message; and
displaying the second group aggregated message in the group conversation page of the first communication group.

19. The storage medium according to claim 14, wherein the computer program further causes the processor to implement:
displaying a candidate application list in response to a group addition request of a target object for the social group channel; wherein the candidate application list comprises at least one candidate application program; and the target object is an object that initiates the channel message transmission operation, and the target object belongs to at least one communication group of the M communication groups;
displaying, in response to a selection operation performed on a second application program in the candidate application list, the second communication group associated with the target object in the second application program; and
adding an object in the second communication group to the social group channel in response to a selection operation performed on a second communication group associated with the target object in the second application program.

20. The storage medium according to claim 19, wherein the adding an object in the second communication group to the social group channel in response to a selection operation performed on a second communication group associated with the target object in the second application program comprises:
generating an addition authorization request in response to the selection operation on the second communication group associated with the target object in the second application program; wherein the addition authorization request is configured for adding an object in the second communication group to the social group channel;
transmitting the addition authorization request to the object in the second communication group; and
adding the object in the second communication group to the social group channel in response to that an authorization permission message transmitted by the object in the second communication group is received.
